(19) United States
(12) Patent Application Publication
(10) Pub. No.: US 2011/0201531 A1
(43) Pub. Date: Aug. 18, 2011

(54) Method for Treating Hydrocarbon-Bearing Formations with Fluorinated Epoxides

(75) Inventors: Mukul M. Sharma, Austin, TX (US); Gary A. Pope, Cedar Park, TX (US); Steven J. Martin, St. Paul, MN (US); Rudolf J. Dams, St. Paul, MN (US); Xai-Ming Qui, St. Paul, MN (US)

(73) Assignees: Board of Regents, The University of Texas System, Austin, TX (US); 3M Innovative Properties Company, St. Paul, MN (US)

(21) Appl. No.: 12/995,929

(22) PCT Filed: May 20, 2009
(86) PCT No.: PCT/US2009/044662

§ 371 Date: Feb. 22, 2011

Related U.S. Application Data
(60) Provisional application No. 61/058,136, filed on Jun. 2, 2008.
(60) Provisional application No. 61/177,201, filed on May 11, 2009.

(51) Int. Cl. C09K 8/60; C09K 8/80

(52) U.S. Cl. 507/205

(57) ABSTRACT

A method of treating a hydrocarbon-bearing formation with a fluorinated epoxide and a treated hydrocarbon-bearing formation. A method of making proppants is also disclosed, which includes combining a plurality of particles with a fluorinated epoxide. The particles comprise at least one of sand, resin-coated sand, ceramic, thermoplastic, clay, bauxite, nut or seed shells, fruit pits, or wood. A particle treated with a ring-opened product of a fluorinated epoxide is also disclosed, wherein the particle comprises one of sand, resin-coated sand, ceramic, thermoplastic, clay, bauxite, nut or seed shells, fruit pits, or wood.

### BACKGROUND

It is known in the subterranean well drilling art that in some wells (e.g., some oil and/or gas wells) brine is present in hydrocarbon-bearing geological formations in the vicinity of the wellbore (also known in the art as the “near wellbore region”). The brine may be naturally occurring (e.g., connate water) and/or may be a result of operations conducted on the well. A decrease in productivity of an oil and/or gas well that results from brine present in the near wellbore region is commonly called “water blocking”.

In the case of some wells, two phases of hydrocarbons (i.e., an oil phase and a gas phase) may accumulate in the near wellbore region, for example, as condensate forms in a gas well at or below the dew point or as the pressure falls below the saturation pressure (bubble point) in an oil well. The presence of two phases of hydrocarbons can cause a large decrease both gas and oil or condensate relative permeabilities.

The presence of brine and/or the presence of two phases of hydrocarbons in a near wellbore region of an oil and/or gas well can inhibit or stop production of hydrocarbons from the well, and hence is typically undesirable. Conventional treatments for increasing the hydrocarbon production from such wells (e.g., a fracturing and propping operation or a solvent flush) often achieve limited success. For example, fluids used in a fracturing operation can be difficult to clean up once the operation has been carried out. Some hydrocarbon and fluorochemical compounds have been reported to modify the wettability of reservoir rock, which may be useful, for example, to prevent or remedy water blocking (e.g., in oil or gas wells) or liquid hydrocarbon accumulation (e.g., in gas wells) in the vicinity of the well bore (i.e., the near well bore region). Not all hydrocarbon and fluorochemical compounds, however, provide the desired wettability modification. And some of these compounds modify the wettability of clastic hydrocarbon-bearing formations but not non-clastic formations, or vice versa. Hence, there is a continuing need for alternative and/or improved techniques for increasing the productivity of oil and/or gas wells that have brine and/or two phases present in a near wellbore region of a hydrocarbon-bearing geological formation.

### SUMMARY

In one aspect, the present disclosure provides a method comprising treating a hydrocarbon-bearing formation with a composition comprising a fluorinated epoxide.

In another aspect, the present disclosure provides a method of making proppants, the method comprising treating a plurality of particles with a composition comprising a fluorinated epoxide, wherein the plurality of particles comprises at least one of sand, resin-coated sand, ceramic, thermoplastic, clay, bauxite, nut or seed shells, fruit pits, or wood.

In another aspect, the present disclosure provides a hydrocarbon-bearing formation comprising a surface, wherein at least a portion of the surface is treated with the fluorinated epoxide disclosed herein.

In some embodiments of the above aspects, the fluorinated epoxide is represented by formula:

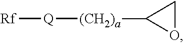

wherein
   Rf is a partially or fully fluorinated aliphatic group optionally interrupted with at least one oxygen atom or a polyfluoropolyethergroup having at least 10 fluorinated carbon atoms and at least three —O— groups;
   Q is selected from the group consisting of a bond, alkylene, arylene, alkylarylene, arylalkylene, —O—, —C(O)—, —S(O)₀₋₂—, —N(R)—, —SO₂N(R)—, —C(O)N(R)—, —C(O)—O—, —O—C(O)—, —O—C(O)—N(R)—, —N(R)—C(O)—O—, and —N(R)—C(O)—N(R)—, wherein alkylene, arylene, alkylarylene, and arylalkylene are each optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, and wherein R is selected from the group consisting of hydrogen, alkyl having up to 4 carbon atoms,

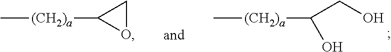

and
each a is independently 0 or 1.

In some of these embodiments, the fluorinated epoxide comprises at least one of:

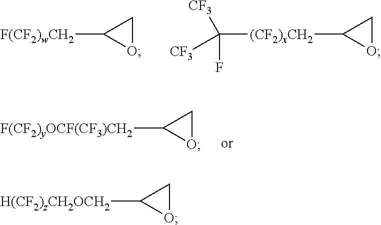

wherein
   w and z are each independently 1 to 10;
   x is a number from 0 to 10; and
   y is a number from 1 to 8.

In some of these embodiments, the fluorinated epoxide is

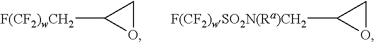

or a combination thereof, wherein w is a number from 6 to 10; w′ is a number from 3 to 6; and R^{a} is alkyl having up to 4 carbon atoms.

In other embodiments of the above aspects, the fluorinated epoxide is a polymeric fluorinated epoxide comprising a first divalent unit represented by formula:

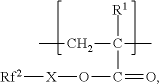

and a second divalent unit comprising a pendent epoxide,
wherein
   Rf² is a fluoroalkyl group optionally containing at least one —O— group or a polyfluoropolyethergroup having at least 10 fluorinated carbon atoms and at least three —O— groups;
   X is selected from the group consisting of alkylene, arylene, alkylarylene, arylalkylene, each optionally containing at least one of —O—, —C(O)—, —S(O)₀₋₂—, —N(R²)—, —SO₂N(R²—, —C(O)N(R²)—, —C(O)—O—, —O—C(O)—, —OC(O)—N(R²)—, —N(R²)—C(O)—O—, or N(R²)—C(O)—N(R²)—, wherein each R² is independently hydrogen or alkyl having up to 4 carbon atoms; and
   R¹ is hydrogen or alkyl having up to 4 carbon atoms.

In some of these embodiments, Rf² is a polyfluoropolyether group having at least 10 fluorinated carbon atoms and at least three —O— groups, X is alkylene, —C(O)—N(R²)-alkylene-, or —C(O)—O-alkylene-, and the second divalent units are represented by formula:

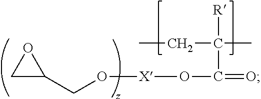

wherein
X′ is alkylene optionally containing at least one —O— group;
R′ is hydrogen or alkyl having up to four carbon atoms; and z is 1 or 2.

In some embodiments of the method of treating a hydrocarbon-bearing formation, the composition further comprises at least one of organic solvent or water. In some embodiments, the organic solvent comprises at least one of a monohydroxy alcohol having up to 4 carbon atoms, ethylene glycol, acetone, a glycol ether, supercritical carbon dioxide, or liquid carbon dioxide. In some embodiments, the solvent comprises a monohydroxy alcohol having up to 4 carbon atoms (e.g., ethanol or isopropanol).

In some embodiments of the method of treating a hydrocarbon-bearing formation and the treated hydrocarbon-bearing formation, the hydrocarbon-bearing formation has at least one of brine or liquid hydrocarbons. Practicing the present disclosure may be useful, for example, in hydrocarbon-bearing formations, wherein two phases (i.e., a gas phase and an oil phase) of the hydrocarbons are present (e.g., in gas wells having retrograde condensate and oil wells having black oil or volatile oil) or when water blocking is present in the formation, and may result in an increase in permeability of at least one of gas, oil, or condensate. In some embodiments, the hydrocarbon-bearing formation has a gas permeability, and treating the formation with the fluorinated epoxide increases the gas permeability of the formation. In some embodiments, the gas permeability after treating the hydrocarbon-bearing formation with the fluorinated epoxide is increased by at least 5 percent (in some embodiments, by at least 10, 15, 20, 30, 40, 50, 60, 70, 80, 90, or even 100 percent or more) relative to the gas permeability of the formation before treating the formation with the composition. In some embodiments, the gas permeability is a gas relative permeability. In some embodiments, the liquid (e.g., oil or condensate) permeability in the hydrocarbon-bearing formation is increased (in some embodiments, by at least 5, 10, 15, 20, 30, 40, 50, 60, 70, 80, 90, or even 100 percent or more) after treating the formation with the fluorinated epoxide.

In some embodiments of the method of treating the hydrocarbon-bearing formation and the treated hydrocarbon-bearing formation, the hydrocarbon-bearing formation is a clastic formation, comprising, for example, at least one of shale, conglomerate, diatomite, sand, or sandstone. In some embodiments, the hydrocarbon-bearing formation is predominantly sandstone (i.e., at least 50 percent by weight sandstone). In some embodiments, the hydrocarbon-bearing formation is a non-clastic formation, comprising, for example, at least one of limestone or dolomite. In some embodiments, the hydrocarbon-bearing formation is predominantly limestone (i.e., at least 50 percent by weight limestone). Typically, and unexpectedly, treating the hydrocarbon-bearing formation with the fluorinated epoxide provides an increase in gas permeability regardless of whether the formation is a clastic formation or a non-clastic formation.

In some embodiments of the method of treating the hydrocarbon-bearing formation, the hydrocarbon-bearing formation has a temperature of less than 135° C. (in some embodiments, up to 130, 125, 120, 115, 110, 105, or 100° C.). For example, the temperature may be about 35° C. to 130° C., 35° C. to 120° C., 35° C. to 110° C., 35° C. to 100° C., 35° C. to 90° C., 35° C. to 85° C., or 35° C. to 80° C.

In some embodiments of the method of treating a hydrocarbon-bearing formation, the hydrocarbon-bearing formation is penetrated by a well bore, and a region near the well bore is treated with the fluorinated epoxide. In some of these embodiments, the method further comprises obtaining (e.g., producing or pumping) hydrocarbons from the well bore after treating the hydrocarbon-bearing formation with the fluorinated epoxide. In some embodiments, the method further comprises flushing the hydrocarbon-bearing formation with a fluid before treating the formation with the fluorinated epoxide. In some embodiments, the hydrocarbon-bearing formation has at least one fracture, and the fracture has a plurality of proppants therein.

In one aspect, the present disclosure provides a hydrocarbon-bearing formation comprising a surface, wherein at least a portion of the surface is treated with a ring-opened product of a fluorinated epoxide. In some embodiments, the ring-opened product of the fluorinated epoxide is bonded to the formation.

In one aspect, the present disclosure provides an article comprising a particle treated with a ring-opened product of a fluorinated epoxide, wherein the particle comprises one of sand, resin-coated sand, ceramic, thermoplastic, clay, bauxite, nut or seed shells, fruit pits, or wood. In some embodiments, the ring-opened product of a fluorinated epoxide is bonded to the particle.

In one aspect, the present disclosure provides a plurality of particles comprising the treated particle according to the present disclosure. In some embodiments, the plurality of particles comprises at least 5, 10, 15, 20, 25, 30, 35, 40, 45, 50, 55, 60, 65, 70, 75, 80, 85, 90, 95, 96, 97, 98, 99, or even at least 100 percent by weight of the treated particles.

In another aspect, the present disclosure provides a method of fracturing a subterranean hydrocarbon-bearing formation, the method comprising injecting a hydraulic fluid into the subterranean hydrocarbon-bearing formation at a rate and pressure sufficient to open a fracture therein, and injecting into the fracture a fluid comprising the plurality of particles.

In some embodiments of hydrocarbon-bearing formations or particles treated with a ring-opened product of a fluorinated epoxide the ring-opened product is a polymer comprising a first divalent unit represented by formula:

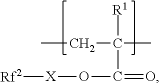

and a second divalent unit comprising a pendent ring-opened epoxide,
wherein
   Rf² is a fluoroalkyl group optionally containing at least one —O— group or a polyfluoropolyether having at least 10 fluorinated carbon atoms and at least three —O— groups;
   X is selected from the group consisting of alkylene, arylene, alkylarylene, arylalkylene, each optionally containing at least one of —O—, —C(O)—, —S(O)₀₋₂—, —N(R²)—, —SO₂N(R²)—, —C(O)N(R²)—, —C(O)—O—, —O—C(O)—, —OC(O)—N(R²)—, —N(R²)—C(O)—O—, or —N(R²)—C(O)—N(R²)—, wherein each R² is independently hydrogen or alkyl having up to 4 carbon atoms; and
   R¹ is hydrogen or alkyl having up to 4 carbon atoms.

In some embodiments of hydrocarbon-bearing formations or particles treated with a ring-opened product of a fluorinated epoxide the ring-opened product is represented by formula:

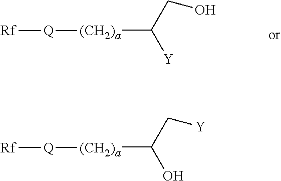

wherein
   Rf is a partially or fully fluorinated aliphatic group optionally interrupted with at least one oxygen atom or a polyfluoropolyether having at least 10 fluorinated carbon atoms and at least three —O— groups;
   Q is selected from the group consisting of a bond, alkylene, arylene, alkylarylene, arylalkylene, —O—, —C(O)—, —S(O)₀₋₂—, —N(R)—, —SO₂N(R)—, —C(O)N(R)—, —C(O)—O—, —O—C(O)—, —O—C(O)—N(R)—, —N(R)—C(O)—O—, and —N(R)—C(O)—N(R)—, wherein alkylene, arylene, alkylarylene, and arylalkylene are each optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, and wherein R is selected from the group consisting of hydrogen, alkyl having up to 4 carbon atoms, and

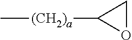

or a ring-opened analog thereof;
each a is independently 0 or 1; and
Y is hydroxyl or a bond to the surface.

In some embodiments of hydrocarbon-bearing formations or particles treated with a ring-opened product of a fluorinated epoxide, the ring-opened product is a fluorinated polyether, wherein the fluorinated polyether is a polymerization product of at least one fluorinated epoxide, and wherein the fluorinated polyether is free of repeating units represented by formula —CH₂—CH₂—O—. In some embodiments, the fluorinated polyether comprises repeating units (e.g., at least 2, 5, 10, 15, 20, 25, 30, 40, 50, or even at least 100 repeating units) represented by formula:

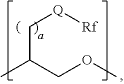

wherein
   Rf is a partially or fully fluorinated aliphatic group optionally interrupted with at least one oxygen atom or a polyfluoropolyether having at least 10 fluorinated carbon atoms and at least three —O— groups;
   Q is selected from the group consisting of a bond, alkylene, arylene, alkylarylene, arylalkylene, —O—, —C(O)—, —S(O)₀₋₂—, —N(R)—, —SO₂N(R)—, —C(O)N(R)—, —C(O)—O—, —O—C(O)—, —O—C(O)—N(R)—, —N(R)—C(O)—O—, and —N(R)—C(O)—N(R)—, wherein alkylene, arylene, alkylarylene, and arylalkylene are each optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, and wherein R is selected from the group consisting of hydrogen, alkyl having up to 4 carbon atoms, and

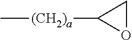

or a ring-opened analog thereof; and
each a is independently 0 or 1.

In some embodiments, the fluorinated polyether comprises repeating units (e.g., at least 2, 5, 10, 15, 20, 25, 30, 40, 50, or even at least 100 repeating units) represented by formula:

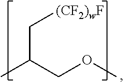

wherein w is a value from 1 to 10.

In one aspect, the present disclosure provides a composition comprising a polymeric fluorinated epoxide comprising a first divalent unit represented by formula:

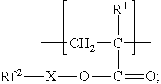

a second divalent unit comprising a pendent epoxide; and

a polyalkyleneoxy segment;
wherein
   Rf² is a polyfluoropolyether group having at least 10 fluorinated carbon atoms and at least three —O— groups or a polyfluoropolyethergroup having at least 10 fluorinated carbon atoms and at least three —O— groups;
   X is selected from the group consisting of alkylene, arylene, alkylarylene, arylalkylene, each optionally containing at least one of —O—, —C(O)—, —S(O)₀₋₂—, —N(R²)—, —SO₂N(R²)—, —C(O)N(R²)—, —C(O)—O—, —O—C(O)—, —OC(O)—N(R²)—, —N(R²)—C(O)—O—, or —N(R²)—C(O)—N(R²)—, wherein each R² is independently hydrogen or alkyl having up to 4 carbon atoms; and
   R¹ is hydrogen or alkyl having up to 4 carbon atoms.

### BRIEF DESCRIPTION OF DRAWINGS

FIG. 1 is a schematic illustration of an exemplary embodiment of an offshore oil platform operating an apparatus for progressively treating a near wellbore region according to some embodiments of the present disclosure; and

FIG. 2 is a schematic illustration of the core flood set-up used for the Examples.

### DETAILED DESCRIPTION

To facilitate the understanding of this disclosure, a number of terms are defined below. Terms defined herein have meanings as commonly understood by a person of ordinary skill in the areas relevant to the present disclosure. Terms such as “a”, “an”, “at least one”, and “the” are not intended to refer to only a singular entity, but include the general class of which a specific example may be used for illustration. The terminology herein is used to describe specific embodiments of the disclosure, but their usage does not delimit the invention, except as outlined in the claims.

The following definitions of terms apply throughout the specification and claims.

The phrase “comprises at least one of followed by a list refers to comprising any one of the items in the list and any combination of two or more items in the list.

The term “treating” includes placing a fluorinated epoxide within a hydrocarbon-bearing formation using any suitable manner known in the art (e.g., pumping, injecting, pouring, releasing, displacing, spotting, or circulating the fluorinated epoxide into a well, well bore, or hydrocarbon-bearing formation.

The term “polymer” refers to a molecule having a structure that essentially includes the multiple repetition of units derived, actually or conceptually, from molecules of low relative molecular mass. The term “polymer” includes “oligomer”.

The term “bonded” refers to having at least one of covalent bonding, hydrogen bonding, ionic bonding, Van Der Waals interactions, pi interactions, London forces, or electrostatic interactions.

“Alkyl group” and the prefix “alk-” are inclusive of both straight chain and branched chain groups and of cyclic groups. Unless otherwise specified, alkyl groups herein have up to 20 carbon atoms. Cyclic groups can be monocyclic or polycyclic and, in some embodiments, have from 3 to 10 ring carbon atoms. “Alkylene” refers to the divalent form or trivalent form of the “alkyl” groups.

“Arylalkylene” refers to an “alkylene” moiety to which an aryl group is attached.

The term “aryl” as used herein includes carbocyclic aromatic rings or ring systems, for example, having 1, 2, or 3 rings and optionally containing at least one heteroatom (e.g., O, S, or N) in the ring. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

“Arylene” is the divalent form of the “aryl” groups defined above.

“Alkylarylene” refers to an “arylene” moiety to which an alkyl group is attached.

The term “productivity” as applied to a well refers to the capacity of a well to produce hydrocarbons; that is, the ratio of the hydrocarbon flow rate to the pressure drop, where the pressure drop is the difference between the average reservoir pressure and the flowing bottom hole well pressure (i.e., flow per unit of driving force).

The phrase “interrupted by at least one functional group” refers to having alkylene or arylalkylene on either side of the functional group. The term “terminated by a functional group” refers to the functional group being connected to either the Rf group or the (CH₂)ₐ group in formula

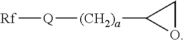

All numerical ranges are inclusive of their endpoints and non-integral values between the endpoints unless otherwise stated.

Fluorinated epoxides (i.e., fluorinated oxiranes) useful for practicing any of the methods of the present disclosure comprise at least one fluorinated segment and at least one epoxide (i.e., oxirane) group. In some embodiments, the fluorinated epoxide comprises one, two, or more fluorinated segments and one, two, or more epoxide groups. The fluorinated segment may be a partially or fully fluorinated aliphatic group that may, for example, have a straight-chain, branched, or cyclic structure or a combination of these structures. Partially fluorinated aliphatic groups may contain chlorine or hydrogen atoms. In some embodiments, the fluorinated segment of the fluorinated epoxide is fully fluorinated. The fluorinated segment may contain up to 20 fluorinated carbon atoms, for example, 1 to 18, 1 to 16, 1 to 14, 1 to 12, 1 to 10, 1 to 8, 3 to 10, 3 to 9, 3 to 8, or 3 to 6 carbon atoms. The fluorinated segment may also contain heteroatoms (e.g., O, S, and N). In some embodiments, the fluorinated segment is interrupted with at least one oxygen atom. In some embodiments, the fluorinated segment is a polyfluoropolyether group, which can be linear, branched, cyclic, or combinations thereof. In some of these embodiments, the polyfluoropolyether group has at least 10 fluorinated carbon atoms and at least three —O— groups.

In some embodiments, fluorinated epoxides useful for practicing the present disclosure comprise at least one of 1) eight or more fluorinated carbon atoms or 2) at least two pendent epoxide groups on a polymeric backbone.

In some embodiments, fluorinated epoxides useful for practicing the present disclosure are represented by Formula I:

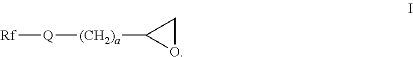

In Formula I, Rf is a partially or fully fluorinated aliphatic group optionally interrupted with at least one (e.g., 1, 2, 3, 4, or 5) oxygen atom or a polyfluoropolyether group having at least 10 fluorinated carbon atoms and at least three —O— groups. In some embodiments, Rf is partially fluorinated and contains at least one (e.g., 1, 2, or 3) hydrogen or chlorine atom. In some embodiments, Rf is fully fluorinated. In some embodiments, Rf is fluoroalkyl having 1 to 20, 1 to 18, 1 to 16, 1 to 14, 1 to 12, 1 to 10, 1 to 8, 3 to 10, 3 to 9, 3 to 8, or 3 to 6 carbon atoms. In some embodiments, Rf is represented by formula R_{f}^{a}—O—(R_{f}^{b}—O—)ₖ(R_{f}^{c})—, wherein R_{f}^{a} is a perfluoroalkyl having 1 to 10 (in some embodiments, 1 to 6, 1 to 4, 2 to 4, or 3) carbon atoms; each R_{f}^{b} is independently a perfluoroalkylene having 1 to 4 (i.e., 1, 2, 3, or 4) carbon atoms; R_{f}^{c} is a perfluoroalkylene having 1 to 6 (in some embodiments, 1 to 4 or 2 to 4) carbon atoms; and k is a number from 2 to 50 (in some embodiments, 2 to 25, 2 to 20, 3 to 20, 3 to 15, 5 to 15, 6 to 10, or 6 to 8). Representative R_{f}^{a} groups include CF₃—, CF₃CF₂—, CF₃CF₂CF₂—, CF₃CF(CF₃)—, CF₃CF(CF₃)CF₂—, CF₃CF₂CF₂CF₂—, CF₃CF₂CF(CF₃)—, CF₃CF₂CF(CF₃)CF₂—, and CF₃CF(CF₃)CF₂CF₂—. In some embodiments, R_{f}^{a} is CF₃CF₂CF₂—. Representative R_{f}^{b} groups include —CF₂—, —CF(CF₃)—, —CF₂CF₂—, —CF(CF₃)CF₂—, —CF₂CF₂CF₂—, —CF(CF₃)CF₂CF₂—, —CF₂CF₂CF₂CF₂—, and —CF₂C(CF₃)₂—. Representative R_{f}^{c} groups include —CF₂—, —CF(CF₃)—, —CF₂CF₂—, —CF₂CF₂CF₂—, and CF(CF₃)CF₂—. In some embodiments, R_{f}^{c} is —CF(CF₃)—. In some embodiments, Rf is selected from the group consisting of C₃F₇O(CF(CF₃)CF₂O)ₙCF(CF₃)—, C₃F₇O(CF₂CF₂CF₂O)ₙCF₂CF₂—, and CF₃O(C₂F₄O)ₙCF₂—, and wherein n has an average value in a range from 3 to 50 (in some embodiments, 3 to 25, 3 to 15, 3 to 10, 4 to 10, or even 4 to 7).

In some embodiments of Formula I, Q is selected from the group consisting of a bond, alkylene, —O—, —SO₂N(R)—, —C(O)N(R)—, wherein alkylene is optionally interrupted or terminated with at least one of —O—, —SO₂N(R)—, or —C(O)N(R)—, and wherein R is selected from the group consisting of hydrogen, alkyl having up to 4 carbon atoms, and

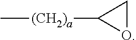

In some embodiments, Q is a bond. In some embodiments, Q is alkylene that is optionally interrupted or terminated with at least one —O—. In some embodiments, Q is —SO₂N(R)—. In some of these embodiments, R is alkyl having up to 4 carbon atoms. In other of these embodiments, R is

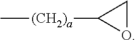

In some embodiments of Formula I, “a” is 0. In some embodiments, “a” is 1.

For treated articles according to the present disclosure, in the ring-opened product of a fluorinated epoxide represented by formula:

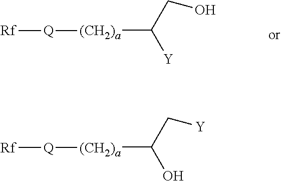

the definitions of Rf, Q, and “a” can be any of those defined above. In some embodiments, Y is hydroxyl. In some embodiments, Y represents a covalent bond to the surface. Fluorinated glycols can be obtained from any of the fluorinated epoxides described herein under hydrolyzing conditions (e.g., in water at elevated temperatures, over time, at high pH, at low pH, or a combination of these conditions). The ring-opened product may become bonded to the surface (i.e., Y is a bond to the surface), for example, if the surface has a nucleophilic group.

For hydrocarbon-bearing formations or treated particles according to the present disclosure, in the fluorinated polyether having repeating units represented by formula:

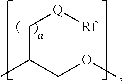

the definitions of Rf, Q, and “a” can be any of those defined above. A fluorinated polyether may form, for example, after the fluorinated epoxide is in contact with the hydrocarbon-bearing formation or the particle. For example, the fluorinated epoxide may polymerize under downhole conditions.

In some embodiments wherein a hydrocarbon-bearing formation or a particle is treated with a fluorinated polyether, the fluorinated polyether has repeating units represented by formula:

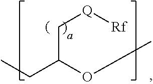

wherein the definitions of Rf, Q, and “a” can be any of those defined above.

In some embodiments, fluorinated epoxides useful for practicing any of the methods of the present disclosure comprise at least one of:

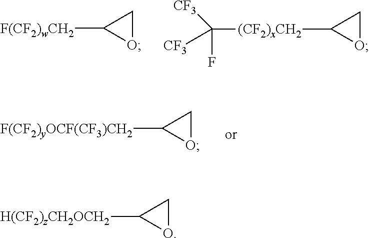

In some embodiments, the fluorinated epoxide is

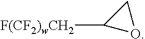

In these embodiments, w may be a number from 1 to 10, 1 to 8, 3 to 8, 3 to 10, 4 to 10, or 6 to 10. In some embodiments, the fluorinated epoxide is

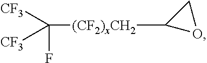

wherein x is a number from 0 to 10, 0 to 8, 2 to 8, 4 to 8, or 4 to 10. In some embodiments, the fluorinated epoxide is

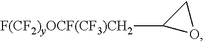

wherein y is a number from 1 to 8, 1 to 6, 1 to 4, or 2 to 6. In some embodiments, the fluorinated epoxide is

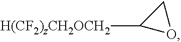

wherein z is a number from 1 to 10, 1 to 8, 2 to 8, 2 to 10, or 4 to 10. In some embodiments, the fluorinated epoxide is

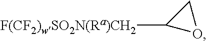

wherein w′ is a number from 1 to 10, 1 to 8, 3 to 8, 3 to 6, or 3 to 5; and R^{a} is alkyl having up to 4 carbon atoms (e.g., methyl or ethyl).

Some fluorinated epoxides useful for practicing the present disclosure are available, for example, from commercial sources (e.g., a variety of fluorinated epoxides having the formulas:

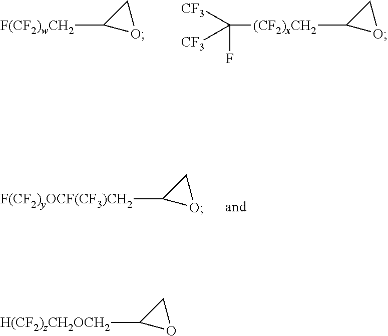

are available from Sigma-Aldrich, St. Louis, Mo., and 1H, 1H, 2H, 3H, 3H-perfluorononylene-1,2-oxide and 1H, 1H, 2H, 3H, 3H-perfluoroheptylene-1,2-oxide are available from ABCR GmbH & Co., Germany). Other fluorinated oxiranes can be prepared by conventional methods. For example, fluorinated alcohols and fluorinated sulfonamides can be treated with epichlorohydrin under basic conditions. Suitable fluorinated alcohols include trifluoroethanol, heptafluorobutanol, or nonafluorohexanol, which are commercially available, for example, from Sigma-Aldrich. Other suitable fluorinated alcohols can be prepared using known techniques, for example, the polymerization of hexafluoropropylene oxide, conversion of the resulting acid fluoride to a methyl ester, and reaction with the methyl ester with an amino alcohol can be carried out using the techniques described in Preparative Example 1 in U.S. Pat. No. 6,995,222 (Buckanin et al.) and column 16, lines 37-62 of U.S. Pat. No. 7,094,829 (Audenaert et al.), the disclosure of which examples are incorporated herein by reference. Suitable fluorinated sulfonamides include N-methylperfluorobutanesulfonamide and N-methylperfluorohexanesulfonamide, which can be prepared according to the methods described in Examples 1 and C6 of U.S. Pat. No. 6,664,534 (Savu et al.), the disclosures of which examples are incorporated herein by reference. Reactions of fluorinated alcohols or fluorinated sulfonamides with epichlorohydrin can be carried out, for example, in aqueous sodium hydroxide in the presence of a phase-transfer reagent such as methyltrialkyl(C8 to C10)ammonium chloride available from Sigma-Aldrich under the trade designation “ADOGEN 464” or in the presence of sodium hydride or sodium methoxide in a suitable solvent (e.g., tetrahydrofuran). Typically, reactions of fluorinated alcohols with epichlorohydrin are carried out at an elevated temperature (e.g., up to 40° C., 60° C., 70° C., or up to the reflux temperature of the solvent), but they may be carried out at room temperature.

In some embodiments of any of the methods disclosed herein, the fluorinated epoxide is a difunctional compound represented by Formula II:

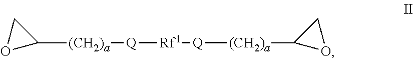

wherein Q and a are as defined in any embodiment above. Rf¹ is a divalent partially or fully fluorinated aliphatic group optionally interrupted with at least one (e.g., 1, 2, 3, 4, or 5) oxygen atom or a divalent polyfluoropolyether having at least 10 fluorinated carbon atoms and at least three —O— groups. In some embodiments, Rf¹ is partially fluorinated and contains at least one (e.g., 1, 2, or 3) hydrogen or chlorine atom. In some embodiments, Rf¹ is fully fluorinated. In some embodiments, Rf¹ is fluoroalkyl having 1 to 20, 1 to 18, 1 to 16, 1 to 14, 1 to 12, 1 to 10, 1 to 8, 3 to 10, 3 to 9, 3 to 8, or 3 to 6 carbon atoms. In some embodiments, Rf¹ is a divalent polyfluoropolyether group. In some of these embodiments Rf¹ is selected from the group consisting of —CF₂O(CF₂O)ᵣ(C₂F₄O)ₘCF₂—, —CF₂O(C₂F₄O)ₘCF₂—, —(CF₂)₃O(C₄F₈O)ₘ(CF₂)₃—, and —CF(CF₃)(OCF₂CF(CF₃))ₛOCₜF₂ₜO(CF(CF₃)CF₂O)ₘCF(CF₃)—, where r can have an average value of 0 to 50, 1 to 50, 3 to 30, 3 to 15, or 3 to 10; m can have an average value of 0 to 50, 3 to 30, 3 to 15, or 3 to 10; s can have an average value of 0 to 50, 1 to 50, 3 to 30, 3 to 15, or 3 to 10; the sum of m and s (i.e., m+s) can have an average value of 0 to 50 or 4 to 40; the sum of r and m (i.e., r+m) is greater than 0; and t can be a number from 2 to 6. Difunctional fluorinated epoxides represented by Formula II can be prepared, for example, by known techniques using commercially available starting materials (e.g., CH₃—OC(O)—CF₂(OCF₂CF₂)₉₋₁₀(OCF₂)₉₋₁₀OCF₂—C(O)—O—CH₃, a perfluoropolyether diester available from Solvay Solexis, Houston, Tex., under the trade designation “FOMBLIN ZDEAL”). For example, a polyfluoropolyether diester can be reduced, for example, with lithium aluminum hydride to a diol using the technique, for example, described in U.S. Pat. No. 3,810,874 (Mitsch et al.). The diol can then be treated with epichlorohydrin or epibromohydrin under the conditions described above.

In some embodiments of any of the methods disclosed herein, the fluorinated epoxide is a polymer comprising fluorinated repeating units and epoxide-containing repeating units. In some of these embodiments, the polymer is an addition copolymer (e.g., made from monomers containing a polymerizable double bond). In some embodiments, fluorinated epoxides useful for practicing the present disclosure comprise a first divalent unit represented by formula III:

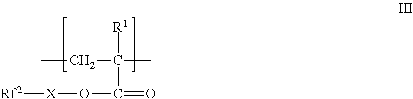

and a second divalent unit comprising a pendent epoxide. Rf² is a fluoroalkyl group optionally containing at least one (e.g., 1, 2, 3, 4, or 5) 13 O— (i.e., ether) group or a polyfluoropolyether having at least 10 fluorinated carbon atoms and at least three —O— groups. In some embodiments, Rf² is partially fluorinated and contains at least one (e.g., 1, 2, or 3) hydrogen or chlorine atom. In some embodiments, Rf² is fully fluorinated. In some embodiments, Rf² is fluoroalkyl having 1 to 20, 1 to 18, 1 to 16, 1 to 14, 1 to 12, 1 to 10, 1 to 8, 3 to 10, 3 to 9, 3 to 8, or 3 to 6 carbon atoms. In some embodiments, Rf² is represented by formula R_{f}^{a}—O—(R_{f}^{b}—O—)ₖ(R_{f}^{c})—, wherein R_{f}^{a}, R_{f}^{b}, and R_{f}^{c} have the same definitions as described above. In some embodiments, Rf² is selected from the group consisting of C₃F₇O(CF(CF₃)CF₂O)ₙCF(CF₃)—, C₃ F₇O(CF₂CF₂CF₂O)ₙCF₂CF₂—, and CF₃O(C₂F₄O)ₙCF₂—, wherein n has an average value in a range from 3 to 50 (in some embodiments, 3 to 25, 3 to 15, 3 to 10, 4 to 10, or even 4 to 7). In some of these embodiments, Rf² is C₃F₇O(CF(CF₃)CF₂O)ₙCF(CF₃)—, wherein n has an average value in a range from 4 to 7. In some embodiments, Rf² is selected from the group consisting of CF₃O(CF₂O)^{x′}(C₂F₄O)_{y′}CF₂— and F(CF₂)₃—O—(C₄F₈O)_{z′}(CF₂)₃—, wherein x′, y′, and z′ each independently has an average value in a range from 3 to 50 (in some embodiments, 3 to 25, 3 to 15, 3 to 10, or even 4 to 10). In some embodiments, Rf² has a number average molecular weight of at least 500 (in some embodiments at least 750 or even 1000) grams per mole. In some embodiments, Rf² has a number average molecular weight of up to 6000 (in some embodiments, 5000 or even 4000) grams per mole. In some embodiments, Rf² has a number average molecular weight in a range from 750 grams per mole to 5000 grams per mole.

In divalent units represented by Formula III, X is selected from the group consisting of alkylene, arylene, alkylarylene, arylalkylene, each optionally containing at least one of —O—, —C(O)—, —S(O)₀₋₂—, —N(R²)—, —SO₂N(R²)—, —C(O)N(R²)—, —C(O)—O—, —O—C(O)—, —OC(O)—N(R²)—, —N(R²)—C(O)—O—, or —N(R²)—C(O)—N(R²)—, and each R² is independently hydrogen or alkyl having up to 4 carbon atoms (e.g., methyl, ethyl, n-propyl, isopropyl, n-butyl, isobutyl, or sec-butyl). In some embodiments, R² is methyl or ethyl.

In divalent units represented by Formula III, R¹ is hydrogen or alkyl having up to 4 carbon atoms (e.g., methyl, ethyl, n-propyl, isopropyl, n-butyl, isobutyl, or sec-butyl). In some embodiments, R¹ is hydrogen or methyl.

Useful second divalent units in fluorinated epoxide polymers comprising first divalent units represented by Formula III may be represented, for example, by formula:

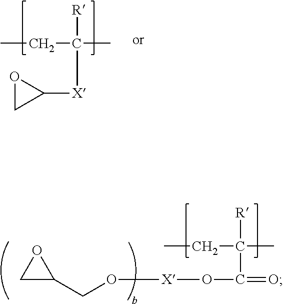

wherein X′ is alkylene optionally containing one or more —O— linkages. R′ is hydrogen or alkyl having up to four carbon atoms (e.g., methyl), and b is 1 or 2. In the polymeric fluorinated epoxides, the first and second divalent groups and any other divalent unit present may be in blocks or randomly connected.

In some embodiments, fluorinated epoxides according to and/or useful for practicing the present disclosure are represented by the general formula:

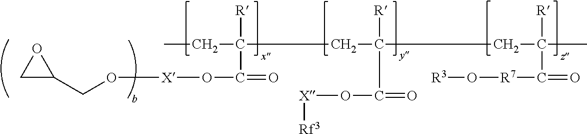

wherein R′, R¹, X′, and b are as defined above, x″ and y″ each independently have a value from 1 to 20 inclusive, wherein the x″, y″, and any z″ units are arranged in blocks or randomly, and Rf³ is a polyfluoropolyether group having at least 10 (in some embodiments, at least 11, 12, 13, 14, 15, 16, 17, 18, 19, or even 20) fluorinated carbon atoms and at least 3 (in some embodiments, at least 4, 5, 6, 7, or even 8) —O— (i.e., ether) groups. In some embodiments, Rf³ has up to 30, 35, 40, or 50 fluorinated carbon atoms and up to 10, 12, 14, or 16 —O— (i.e., ether) groups. In some embodiments the polyfluoropolyether group is perfluorinated. X″ is alkylene (e.g., methylene), —C(O)—N(R²)-alkylene-, or —C(O)—O-alkylene-, wherein R² is as defined above. R⁷ is a poly(alkyleneoxy) segment wherein alkyleneoxy has from 2 to 4 carbon atoms, R³ is hydrogen or alkyl having up to 4 carbon atoms, and z″ is in a range from 0 to 20.

The polyalkyleneoxy segment can comprise a plurality (i.e., multiple) of repeating alkyleneoxy groups having from 2 to 4 or 2 to 3 carbon atoms (e.g., —CH₂CH₂O—, —CH(CH₃)CH₂O—, —CH₂CH(CH₃)O—, —CH₂CH₂CH₂O—, —CH(CH₂CH₃)CH₂O—, —CH₂CH(CH₂CH₃)O—, or —CH₂C(CH₃)₂O—). In some embodiments, the segment comprises a plurality of ethoxy groups, propoxy groups, or combinations thereof. The polyalkyleneoxy segment may have a number average molecular weight of at least 200, 300, 500, 700, or even at least 1000 grams per mole up to 2000, 4000, 5000, 8000, 10000, 15,000, or even up to 20000 grams per mole. Two or more differing alkyleneoxy groups may be distributed randomly in the series or may be present in alternating blocks.

Polymeric fluorinated epoxides may be prepared, for example, by reacting a mixture containing at least first and second components typically in the presence of a chain transfer agent and an initiator to form a composition that includes at least one identifiable structural element due to each of the first and second components. Typically the polymer that is formed has a distribution of molecular weights and compositions.

In some embodiments, the first component is represented by Formula IV:

Rf²—X—O—C(O)—C(R¹)═CH₂ IV,

wherein Rf², R¹, and X are as defined above for a divalent unit of Formula III. In some embodiments, the compound of Formula IV is Rf³—X″—O—C(O)—C(R¹)═CH₂, wherein Rf³ and X″ are as defined above. Compounds of Formula IV can be prepared, for example, using known methods. For example, hexafluoropropylene oxide can be polymerized using known methods as described above to form a polyfluoropolyether terminated with a fluorocarbonyl group (i.e., —C(O)F). This material can be vacuum distilled to remove components having a molecular weight less than 500 (in some embodiments, in some embodiments, less than 600, 700, 750, 800, 900, or even 1000) grams per mole. The fluorocarbonyl group can optionally be converted to a carboxy or alkoxycarbonyl group by conventional methods. Typically, conversion to an alkoxycarbonyl terminated (e.g., conversion to a methyl ester of formula Rf²—C(O)—OCH₃) is carried out. A methyl ester of formula Rf²—C(O)—OCH₃, an acid fluoride of formula Rf²—C(O)—F, or a carboxylic acid of formula Rf²—C(O)—OH can then be converted to a compound of Formula IV using a number of conventional methods. For example, a perfluoropolyether monomer of formula Rf³—(CO)NHCH₂CH₂O(CO)C(R¹)═CH₂ can be prepared by first reacting Rf³—C(O)—OCH₃, for example, with ethanolamine to prepare alcohol-terminated Rf³—(CO)NHCH₂CH₂OH, which can then be reacted with methacrylic acid, methacrylic anhydride, acrylic acid or acryloyl chloride to prepare the compound of Formula IV, wherein R¹ is methyl or hydrogen, respectively. Other amino alcohols (e.g., amino alcohols of formula NR²H-alkylene-OH) can be used in this reaction sequence to provide compounds of Formula II, wherein X″ is —C(O)—N(R²)-alkylene-, and R² is as defined above. In further examples, an ester of formula Rf²—C(O)—OCH₃ or a carboxylic acid of formula Rf²—C(O)—OH can be reduced using conventional methods (e.g., by reduction with a hydride, for example sodium borohydride) to an alcohol of formula Rf²—CH₂OH. The alcohol of formula Rf²—CH₂OH can then be reacted with methacryloyl chloride, for example, to provide a perfluoropolyether monomer of formula Rf²—CH₂O(CO)C(R¹)═CH₂.

Other fluorinated free-radically polymerizable acrylate monomers of formula IV, and methods for their preparation, are known in the art; (see, e.g., U.S. Pat. No. 2,803,615 (Albrecht et al.) and U.S. Pat. No. 6,664,354 (Savu et al.), the disclosures of which, relating to free-radically polymerizable monomers and methods of their preparation, are incorporated herein by reference). Methods described for making nonafluorobutanesulfonamido group-containing structures can be used to make heptafluoropropanesulfonamido groups by starting with heptafluoropropanesulfonyl fluoride, which can be made, for example, by the methods described in Examples 2 and 3 of U.S. Pat. No. 2,732,398 (Brice et al.), the disclosure of which is incorporated herein by reference. 2,2,3,3,4,4,4-Heptafluorobutyl 2-methylacrylate is also known; (see, e.g., EP1311637 B1, published Apr. 5, 2006, and incorporated herein by reference for the disclosure of the preparation of 2,2,3,3,4,4,4-heptafluorobutyl 2-methylacrylate). Other compounds of Formula IV are available, for example, from commercial sources (e.g., 3,3,4,4,5,5,6,6,6-nonafluorohexyl acrylate from Daikin Chemical Sales, Osaka, Japan and 3,3,4,4,5,5,6,6,6-nonafluorohexyl 2-methylacrylate from Indofine Chemical Co., Hillsborough, N.J.).

Second components useful for the preparation of polymeric fluorinate epoxides comprise at least one polymerizalbe double bond and at least one epoxide. Useful second components include several commercially available acrylates-epoxides (e.g., glycidyl methacrylate, glycidyl acrylate, 2-oxiranylmethoxy-ethyl acrylate, and 2-oxiranylmethoxy-ethyl methacrylate). Acrylates or methacrylates can also be prepared using conventional techniques from epoxy-alcohols (e.g., 2-methyl-2,3-epoxy-1-propanol, glycerol digylycidyl ether, 1,3-digylcidyl glyceryl ether, trimethylolpropane-diglycidyl ether, and 2-[1-oxiran-2-ylmethyl)piperidin-2-yl]ethanol). Other useful second components include allyl glycidyl ether, butadiene monoxide, 1,2-epoxy-7-octene, 1,2-epoxy-5-hexene, 4-vinyl-1-cyclohexene 1,2-epoxide, allyl-11,12-epoxy stearate, 1,2-epoxy-9-decene, limonene oxide, isoprene monoxide, and 1-ethynyl-3-(oxiran-2-ylmethoxy)-benzene.

For some embodiments of polymeric fluorinated epoxides useful in practicing the present disclosure, the first divalent units are present in a range from 15 to 80, 20 to 80, 25 to 75, or 25 to 65 percent by weight, based on the total weight of the polymeric fluorinated epoxide. In some embodiments, the second divalent units are present in a range from 20 to 85, 25 to 85, 25 to 80, or 30 to 70 percent by weight, based on the total weight of the polymeric fluorinated epoxide. In some embodiments each of the first divalent units and the second divalent units are each present in a range from 35 to 65 percent by weight, based on the total weight of the polymeric fluorinated epoxide. For some embodiments, the mole ratio of first divalent units to second divalent units in the polymeric fluorinated epoxide is 4:1, 3:1, 2:1, 1:1, 1:2, or 1:3.

The reaction of at least one first component and at least one second component is typically carried out in the presence of an added free-radical initiator. Free radical initiators such as those widely known and used in the art may be used to initiate polymerization of the components. Exemplary free-radical initiators are described in U.S. Pat. No. 6,995,222 (Buckanin et al.), the disclosure of which is incorporated herein by reference.

Polymerization reactions may be carried out in any solvent suitable for organic free-radical polymerizations. The components may be present in the solvent at any suitable concentration, (e.g., from about 5 percent to about 90 percent by weight based on the total weight of the reaction mixture). Examples of suitable solvents include aliphatic and alicyclic hydrocarbons (e.g., hexane, heptane, cyclohexane), aromatic solvents (e.g., benzene, toluene, xylene), ethers (e.g., diethyl ether, glyme, diglyme, diisopropyl ether), esters (e.g., ethyl acetate, butyl acetate), ketones (e.g., acetone, methyl ethyl ketone, methyl isobutyl ketone), sulfoxides (e.g., dimethyl sulfoxide), amides (e.g., N,N-dimethylformamide, N,N-dimethylacetamide), halogenated solvents (e.g., methylchloroform, 1,1,2-trichloro-1,2,2-trifluoroethane, trichloroethylene or trifluorotoluene), and mixtures thereof.

Polymerization can be carried out at any temperature suitable for conducting an organic free-radical reaction. Particular temperature and solvents for use can be selected by those skilled in the art based on considerations such as the solubility of reagents, the temperature required for the use of a particular initiator, and the molecular weight desired. While it is not practical to enumerate a particular temperature suitable for all initiators and all solvents, generally suitable temperatures are in a range from about 30° C. to about 200° C.

Free-radical polymerizations may be carried out in the presence of chain transfer agents. Typical chain transfer agents that may be used in the preparation of polymers described herein include carbon tetrabromide; difunctional mercaptans (e.g., di(2-mercaptoethyl)sulfide); and aliphatic mercaptans (e.g., octylmercaptan, dodecylmercaptan, and octadecylmercaptan).

Adjusting, for example, the concentration and activity of the initiator, the concentration of each of the reactive monomers, the temperature, the concentration of the chain transfer agent, and the solvent using techniques known in the art can control the molecular weight of a polyacrylate copolymer. For some embodiments of polymeric fluorinated epoxides useful in practicing the present disclosure, the number average molecular weight of the fluorinated epoxide polymer is in a range from 1500, 2000, 2500, or even 3000 grams per mole up to 10,000, 20,000, 25,000, 30,000, 40,000, 50,000, 60,000, 70,000, 80,000, 90,000, or 100,000 grams per mole although higher molecular weights may also be useful.

Fluorinated polymers according to and/or useful for practicing the present disclosure may contain other divalent units, typically in weight percents up to 20, 15, 10, or 5 percent, based on the total weight of the fluorinated polymer. These divalent units may be incorporated into the polymer chain by selecting additional components for the polymerization reaction such as alkyl acrylates and methacrylates (e.g., octadecyl methacrylate, lauryl methacrylate, butyl acrylate, isobutyl methacrylate, ethylhexyl acrylate, ethylhexyl methacrylate, methyl methacrylate, hexyl acrylate, heptyl methacrylate, cyclohexyl methacrylate, or isobornyl acrylate); allyl esters (e.g., allyl acetate and allyl heptanoate); vinyl ethers or allyl ethers (e.g., cetyl vinyl ether, dodecylvinyl ether, 2-chloroethylvinyl ether, or ethylvinyl ether); alpha-beta unsaturated nitriles (e.g., acrylonitrile, methacrylonitrile, 2-chloroacrylonitrile, 2-cyanoethyl acrylate, or alkyl cyanoacrylates); alpha-beta-unsaturated carboxylic acid derivatives (e.g., allyl alcohol, allyl glycolate, acrylamide, methacrylamide, n-diisopropyl acrylamide, or diacetoneacrylamide), styrene and its derivatives (e.g., vinyltoluene, alpha-methylstyrene, or alpha-cyanomethyl styrene); olefinic hydrocarbons which may contain at least one halogen (e.g., ethylene, propylene, isobutene, 3-chloro-1-isobutene, butadiene, isoprene, chloro and dichlorobutadiene, 2,5-dimethyl-1,5-hexadiene, and vinyl and vinylidene chloride); hydroxyalkyl-substituted polymerizable compounds (e.g., 2-hydroxyethyl methacrylate); and alkyleneoxy-containing polymerizable compounds (e.g., diethylene glycol diacrylate, tri(ethylene glycol)dimethacrylate, tri(ethylene glycol)divinyl ether, and polyoxyalkylene glycol acrylates and diacrylates (e.g., CH₂═CHC(O)O(CH₂CH₂O)₇₋₉H) available, for example, from Nippon Oil & Fats Company, Tokyo, Japan under the trade designation “BLEMMER”). Other useful alkyleneoxy-containing polymerizable compounds can be prepared by known methods, for example, combining one or two equivalents of acryloyl chloride or acrylic acid (or methacryloyl chloride or methacrylic acid) with a polyethylene glycol or a monoalkyl ether thereof having a molecular weight of about 200 to 10,000 grams per mole (e.g., those available from Dow Chemical Company, Midland, Mich., under the trade designation “CARBOWAX”) or a block copolymer of ethylene oxide and propylene oxide having a molecular weight of about 500 to 15000 grams per mole (e.g., those available from BASF Corporation, Ludwigshafen, Germany, under the trade designation “PLURONIC”). The reaction of acrylic acid or methacyrlic acid with a poly(alkylene oxide) is typically carried out in the presence of an acid catalyst and a polymerization inhibitor at an elevated temperature in a suitable solvent; (see, e.g., Example 1 of U.S. Pat. No. 3,787,351 (Olson), the disclosure of which is incorporated by reference herein in its entirety.

In some embodiments, methods according to the present disclosure comprise treating a hydrocarbon-bearing formation with a composition comprising a fluorinated epoxide and at least one of organic solvent or water. As used herein, the term “solvent” refers to a homogeneous liquid material (inclusive of any water with which it may be combined) that is capable of at least partially dissolving the fluorinated epoxide disclosed herein at 25° C. In some embodiments, the solvent is water-miscible. Examples of solvents useful for practicing the methods disclosed herein include polar solvents such as alcohols (e.g., methanol, ethanol, isopropanol, propanol, or butanol), glycols (e.g., ethylene glycol or propylene glycol), glycol ethers (e.g., ethylene glycol monobutyl ether or those glycol ethers available under the trade designation “DOWANOL” from Dow Chemical Co., Midland, Mich.), or acetone; easily gasified fluids such as ammonia, low molecular weight hydrocarbons or substituted hydrocarbons including condensate, or supercritical or liquid carbon dioxide; and mixtures thereof.

In some embodiments, compositions useful in practicing the present disclosure contain two or more different solvents. In some embodiments, the compositions comprise at least one of a polyol or polyol ether independently having from 2 to 25 (in some embodiments, 2 to 15, 2 to 10, 2 to 9, or even 2 to 8) carbon atoms and at least one of water, a monohydroxy alcohol, an ether, or a ketone, wherein the monohydroxy alcohol, the ether, and the ketone each independently have up to 4 carbon atoms. In some of these embodiments, the polyol or polyol ether is present in the composition at at least 50, 55, 60, or 65 percent by weight and up to 75, 80, 85, or 90 percent by weight, based on the total weight of the composition. The term “polyol” refers to an organic molecule consisting of C, H, and O atoms connected one to another by C—H, C—C, C—O, O—H single bonds, and having at least two C—O—H groups. In some embodiments, useful polyols (e.g., diols or glycols) have 2 to 25, 2 to 20, 2 to 15, 2 to 10, 2 to 8, or even 2 to 6 carbon atoms. In some embodiments, the solvent comprises a polyol ether. The term “polyol ether” refers to an organic molecule consisting of C, H, and O atoms connected one to another by C—H, C—C, C—O, O—H single bonds, and which is at least theoretically derivable by at least partial etherification of a polyol. In some embodiments, the polyol ether has at least one C—O—H group and at least one C—O—C linkage. Useful polyol ethers (e.g., glycol ethers) may have from 3 to 25 carbon atoms, 3 to 20, 3 to 15, 3 to 10, 3 to 9, 3 to 8, or even from 5 to 8 carbon atoms. In some embodiments, the polyol is at least one of ethylene glycol, propylene glycol, polypropylene glycol), 1,3-propanediol, or 1,8-octanediol, and the polyol ether is at least one of 2-butoxyethanol, diethylene glycol monomethyl ether, ethylene glycol monobutyl ether, dipropylene glycol monomethyl ether, or 1-methoxy-2-propanol. In some embodiments, the polyol and/or polyol ether has a normal boiling point of less than 450° F. (232° C.), which may be useful, for example, to facilitate removal of the polyol and/or polyol ether from a well after treatment. In these embodiments, in the event that a component of the solvent is a member of two functional classes, it may be used as either class but not both. For example, ethylene glycol methyl ether may be a polyol ether or a monohydroxy alcohol, but not as both simultaneously. In these embodiments, each solvent component may be present as a single component or a mixture of components. Useful combinations of two solvents include 1,3-propanediol (80%)/isopropanol (IPA) (20%), propylene glycol (70%)/IPA (30%), propylene glycol (90%)/IPA (10%), propylene glycol (80%)/IPA (20%), ethylene glycol (50%)/ethanol (50%), ethylene glycol (70%)/ethanol (30%), propylene glycol monobutyl ether (PGBE) (50%)/ethanol (50%), PGBE (70%)/ethanol (30%), dipropylene glycol monomethyl ether (DPGME) (50%)/ethanol (50%), DPGME (70%)/ethanol (30%), diethylene glycol monomethyl ether (DEGME) (70%)/ethanol (30%), triethylene glycol monomethyl ether (TEGME) (50%)/ethanol (50%), TEGME (70%)/ethanol (30%), 1,8-octanediol (50%)/ethanol (50%), propylene glycol (70%)/tetrahydrofuran (THF) (30%), propylene glycol (70%)/acetone (30%), propylene glycol (70%), methanol (30%), propylene glycol (60%)/IPA (40%), 2-butoxyethanol (80%)/ethanol (20%), 2-butoxyethanol (70%)/ethanol (30%), 2-butoxyethanol (60%)/ethanol (40%), propylene glycol (70%)/ethanol (30%), ethylene glycol (70%)/IPA (30%), and glycerol (70%)/IPA (30%), wherein the exemplary percentages are by weight are based on the total weight of solvent.

Typically, in compositions useful for practicing the methods described herein, the fluorinated epoxide is present in the composition at at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.5, 1, 1.5, 2, 3, 4, or 5 percent by weight, up to 5, 6, 7, 8, 9, or 10 percent by weight, based on the total weight of the composition. For example, the amount of the fluorinated polymer in the compositions may be in a range from 0.01 to 10, 0.1 to 10, 0.1 to 5, 1 to 10, or even in a range from 1 to 5 percent by weight, based on the total weight of the composition. Lower and higher amounts of the fluorinated epoxide in the compositions may also be used, and may be desirable for some applications.

In some embodiments of the method of treating a hydrocarbon-bearing formation disclosed herein, the hydrocarbon-bearing formation has brine. The brine present in the formation may be from a variety of sources and may be at least one of connate water, flowing water, mobile water, immobile water, residual water from a fracturing operation or from other downhole fluids, or crossflow water (e.g., water from adjacent perforated formations or layers in the formation). In some embodiments, the brine is connate water. The term “brine” refers to water having at least one dissolved electrolyte salt therein (e.g., sodium chloride, calcium chloride, strontium chloride, magnesium chloride, potassium chloride, ferric chloride, ferrous chloride, and hydrates thereof). Unless otherwise specified, the brine may have any nonzero concentration, and which in some embodiments may be less than 1000 parts per million by weight (ppm), or at least 1000 ppm, at least 10,000 ppm, at least 20,000 ppm, 25,000 ppm, 30,000 ppm, 40,000 ppm, 50,000 ppm, 100,000 ppm, 150,000 ppm, or even at least 200,000 ppm.

Although not wanting to be bound by theory, it is believed that the effectiveness of the treatment methods disclosed herein for improving hydrocarbon productivity of a particular oil and/or gas well having brine accumulated in the near wellbore region will typically be determined by the ability of the composition to dissolve or displace the quantity of brine present in the near wellbore region of the well without causing precipitation of the fluorinated epoxide or salt. Hence, at a given temperature greater amounts of compositions having lower brine solubility (i.e., compositions that can dissolve a relatively lower amount of brine) will typically be needed than in the case of compositions having higher brine solubility and containing the same fluorinated epoxide at the same concentration.

In some embodiments of treatment methods according to the present disclosure, the method further comprises receiving data comprising a temperature and a brine composition of the hydrocarbon-bearing formation and selecting a treatment composition for the hydrocarbon-bearing formation comprising a fluorinated epoxide and at least one of organic solvent or water, wherein, at the temperature, a mixture of an amount of the brine composition and the treatment composition does not result in precipitation or phase separation. Phase behavior can be evaluated prior to treating the hydrocarbon-bearing formation with the composition by obtaining a sample of the brine from the hydrocarbon-bearing formation and/or analyzing the composition of the brine from the hydrocarbon-bearing formation and preparing an equivalent brine having the same or similar composition to the composition of the brine in the formation. The brine saturation level in a hydrocarbon-bearing formation can be determined using methods known in the art and can be used to determine the amount of brine that can be mixed with the composition containing the fluorinated epoxide. The brine and the composition (i.e., the fluorinated epoxide-solvent and/or water composition) are typically combined (e.g., in a container) at the temperature and then mixed together (e.g., by shaking or stirring). The mixture is then maintained at the temperature for 15 minutes, removed from the heat, and immediately visually evaluated to see if it phase separates or if cloudiness or precipitation occurs.

The phase behavior of the composition and the brine can be evaluated over an extended period of time (e.g., 1 hour, 12 hours, 24 hours, or longer) to determine if any phase separation, precipitation, or cloudiness is observed. By adjusting the relative amounts of brine (e.g., equivalent brine) and the fluorinated epoxide composition, it is possible to determine the maximum brine uptake capacity (above which phase separation or salt precipitation occurs) of the fluorinated polymer-solvent composition at a given temperature. Varying the temperature at which the above procedure is carried out typically results in a more complete understanding of the suitability of fluorinate polymer-solvent compositions as treatment compositions for a given well.

In some embodiments of the method of treating a hydrocarbon-bearing formation disclosed herein, the hydrocarbon-bearing formation has liquid hydrocarbons. In some embodiments, the hydrocarbon-bearing formation has at least one of gas condensate, black oil, or volatile oil. In some of these embodiments, the hydrocarbon-bearing formation has at least one of black oil or volatile oil. The term “black oil” refers to the class of crude oil typically having gas-oil ratios (GOR) less than about 2000 scf/stb (356 m³/m³). For example, a black oil may have a GOR in a range from about 100 (18), 200 (36), 300 (53), 400 (71), or even 500 scf/stb (89 m³/m³) up to about 1800 (320), 1900 (338), or even 2000 scf/stb (356 m³/m³). The term “volatile oil” refers to the class of crude oil typically having a GOR in a range between about 2000 and 3300 scf/stb (356 and 588 m³/m³). For example, a volatile oil may have a GOR in a range from about 2000 (356), 2100 (374), or even 2200 scf/stb (392 m³/m³) up to about 3100 (552), 3200 (570), or even 3300 scf/stb (588 m³/m³). In some embodiments, the hydrocarbon-bearing formation has retrograde gas condensate (e.g., at least one of methane, ethane, propane, butane, pentane, hexane, heptane, or octane).

Methods of treating a hydrocarbon-bearing formation according to the present disclosure may be practiced, for example, in a laboratory environment (e.g., on a core sample (i.e., a portion) of a hydrocarbon-bearing formation) or in the field (e.g., on a subterranean hydrocarbon-bearing formation situated downhole). Typically, the methods disclosed herein are applicable to downhole conditions having a pressure in a range from about 1 bar (100 kPa) to about 1000 bars (100 MPa) and have a temperature in a range from about 100° F. (37.8° C.) to 400° F. (204° C.) although the methods are not limited to formations having these conditions. The skilled artisan, after reviewing the instant disclosure, will recognize that various factors may be taken into account in practice of the any of the disclosed methods including, for example, the ionic strength of the brine, pH (e.g., a range from a pH of about 4 to about 10), and the radial stress at the wellbore (e.g., about 1 bar (100 kPa) to about 1000 bars (100 MPa)).

In the field, treating a hydrocarbon-bearing formation with a composition described herein can be carried out using methods (e.g., by pumping under pressure) well known to those skilled in the oil and gas art. Coil tubing, for example, may be used to deliver the treatment composition to a particular geological zone of a hydrocarbon-bearing formation. In some embodiments of practicing the methods described herein it may be desirable to isolate a geological zone (e.g., with conventional packers) to be treated with the composition.

Practicing the present disclosure may be useful, for example, on both existing and new wells. Typically, it is believed to be desirable to allow for a shut-in time after fluorinated epoxides or compositions comprising fluorinated epoxides described herein treat the hydrocarbon-bearing formations. Exemplary set in times include a few hours (e.g., 1 to 12 hours), about 24 hours, or even a few (e.g., 2 to 10) days. After a composition has been allowed to remain in place for a selected time, the solvents present in the composition may be recovered from the formation by simply pumping fluids up tubing in a well as is commonly done to produce fluids from a formation.

In some embodiments of methods according to the present disclosure, the method comprises flushing the hydrocarbon-bearing formation with a fluid before treating the formation with the fluorinated epoxide. The fluid may be useful, for example, for at least partially solubilizing or at least partially displacing at least one of brine or hydrocarbons in the formation. In some embodiments, the fluid at least partially solubilizes brine. In some embodiments, the fluid at least partially displaces brine. The fluid may be useful for decreasing the concentration of at least one of the salts present in the brine prior to introducing the fluorinated epoxide to the hydrocarbon-bearing formation. In some embodiments, the fluid at least one of partially solubilizes or displaces liquid hydrocarbons in the hydrocarbon-bearing formation. In some embodiments, the fluid is substantially free of fluorinated epoxides. A fluid that is substantially free of fluorinated epoxides may be a fluid that has less than 0.01 weight percent, less than 0.005 weight percent, or even 0 weight percent, based on the weight percent of the fluid. In some embodiments, the fluid comprises at least one of toluene, diesel, heptane, octane, or condensate. In some embodiments, the fluid comprises at least one of water, methanol, ethanol, or isopropanol. In some embodiments, the fluid comprises at least one of a polyol or polyol ether independently having from 2 to 25 (in some embodiments, 2 to 15, 2 to 10, 2 to 9, or even 2 to 8) carbon atoms. In some embodiments, useful polyols have 2 to 25, 2 to 20, 2 to 15, 2 to 10, 2 to 8, or even 2 to 6 carbon atoms. Exemplary useful polyols include ethylene glycol, propylene glycol, polypropylene glycol), 1,3-propanediol, trimethylolpropane, glycerol, pentaerythritol, and 1,8-octanediol. In some embodiments, useful polyol ethers may have from 3 to 25 carbon atoms, 3 to 20, 3 to 15, 3 to 10, 3 to 9, 3 to 8, or even from 5 to 8 carbon atoms. Exemplary useful polyol ethers include diethylene glycol monomethyl ether, ethylene glycol monobutyl ether, dipropylene glycol monomethyl ether, 2-butoxyethanol, and 1-methoxy-2-propanol. In some embodiments, the fluid comprises at least one monohydroxy alcohol, ether, or ketone independently having up to four carbon atoms. In some embodiments, the fluid comprises at least one of nitrogen, carbon dioxide, or methane.

In some embodiments of the method of treating a hydrocarbon-bearing formation according to the present disclosure, the method comprises treating the formation with a pretreatment composition comprising a compound represented by formula III:

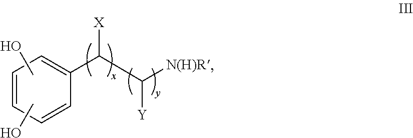

wherein
   each of X and Y is independently a thiol, a halogen, a hydrogen, a hydroxyl, a hydroxyalkyl (e.g., hydroxymethyl), a carboxylic acid, an aldehyde, a carboxylic ester (i.e., —C(O)—O-alkyl), or a carboxamide (i.e., —C(O)—NR′₂);
   R′ is hydrogen, alkyl, or aryl; and
   x and y are each independently 0 to 10, wherein x+y is at least 1,
      before treating the hydrocarbon-bearing formation with the fluorinated epoxide.

The term “alkyl” is inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms. The term “aryl” includes carbocyclic aromatic rings or ring systems, for example, having 1, 2, or 3 rings and optionally containing at least one heteroatom (e.g., O, S, or N) in the ring. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl. In some embodiments, at least one of X or Y is hydrogen. In some embodiments, R′ is hydrogen or alkyl. In some embodiments, R′ is hydrogen. In some embodiments, x and y are each independently 0 to 3, 0 to 2, or 1 to 2. In some embodiments, x+y is 1, 2, or 3. In some embodiments, x+y is 2. In some embodiments, the pretreatment composition comprises at least one of dopamine, epinephrine, norepinephrine, 3-(3,4-dihydroxyphenyl)-2-methylalanine, 3-(3,4-dihydroxyphenyl)alanine, 3-(3,4-dihydroxyphenyl)alanine methyl ester, 3-(3,4-dihydroxyphenyl)-2-methylalanine methyl ester, or a salt thereof. In some embodiments, the pretreatment composition comprises dopamine. Some compounds of Formula III, including dopamine, epinephrine, norepinephrine, 3-(3,4-dihydroxyphenyl)-2-methylalanine, 3-(3,4-dihydroxyphenyl)alanine, 3-(3,4-dihydroxyphenyl)alanine methyl ester, 3-(3,4-dihydroxyphenyl)-2-methylalanine methyl ester, or salts thereof, are available, for example, from commercial sources (e.g., Sigma-Aldrich or TCI America, Portland, Oreg.). These compounds can also be used as starting materials for synthesizing other compounds of Formula III using conventional functional group manipulations (e.g., reduction of a carboxylic acid to a hydroxyalkyl group or an aldehyde, interconversion of carboxylic acid derivatives, and conversion of hydroxyl groups to thiols or halogens).

In some embodiments, the pretreatment composition further comprises at least one of solvent or water. In some of these embodiments, the solvent may be any of the solvents listed above for compositions comprising the fluorinated epoxides. In some embodiments, the solvent comprises a monohydroxy alcohol having up to 4 carbon atoms.

In some embodiments of methods wherein a pretreatment composition is injected into the hydrocarbon-bearing formation, at least one of the hydrocarbon-bearing formation or the pretreatment composition has a pH of greater than 7, in some embodiments, at least 7.5, 8.0, 8.25, 8.4, or at least 8.5. Without wanting to be bound by theory, it is believed that in a hydrocarbon-bearing formation having an alkaline environment, compounds represented by Formula III will undergo polymerization to provide a polymer having a repeating unit represented by formula

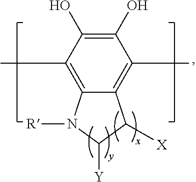

wherein X, Y, R′, x, and y are as defined above for any of the embodiments of Formula III. In some embodiments, hydrocarbon-bearing formations treated with compounds represented by Formula III before treatment with fluorinated epoxides exhibit an increase in at least one of gas or oil permeability that this greater and/or longer lasting than when only the fluorinated epoxide is used to treat hydrocarbon-bearing formation.

In some embodiments of methods or hydrocarbon-bearing formations according to the present disclosure, the hydrocarbon-bearing formation has at least one fracture. In some embodiments, fractured formations have at least 2, 3, 4, 5, 6, 7, 8, 9, or even 10 or more fractures. As used herein, the term “fracture” refers to a fracture that is man-made. In the field, for example, fractures are typically made by injecting a fracturing fluid into a subterranean geological formation at a rate and pressure sufficient to open a fracture therein (i.e., exceeding the rock strength).

In some embodiments of the present disclosure, wherein treating the formation with the fluorinated epoxide provides an increase in at least one of the gas permeability or the liquid hydrocarbon permeability of the formation, the formation is a non-fractured formation (i.e., free of man-made fractures).

In some embodiments of the present disclosure, wherein the hydrocarbon-bearing formation has at least one fracture, the fracture has a plurality of proppants therein. Prior to delivering the proppants into a fracture, the proppants may be treated with the fluorinated epoxide using the method of making proppants according to the present disclosure or may be untreated (e.g., may comprise less than 0.1% by weight fluorinated epoxide, based on the total weight of the plurality of proppants). Exemplary proppants known in the art include those made of sand (e.g., Ottawa, Brady or Colorado Sands, often referred to as white and brown sands having various ratios), resin-coated sand, sintered bauxite, ceramics (i.e., glasses, crystalline ceramics, glass-ceramics, and combinations thereof), thermoplastics, organic materials (e.g., ground or crushed nut shells, seed shells, fruit pits, and processed wood), and clay. Sand proppants are available, for example, from Badger Mining Corp., Berlin, Wis.; Borden Chemical, Columbus, Ohio; and Fairmont Minerals, Chardon, Ohio. Thermoplastic proppants are available, for example, from the Dow Chemical Company, Midland, Mich.; and BJ Services, Houston, Tex. Clay-based proppants are available, for example, from CarboCeramics, Irving, Tex.; and Saint-Gobain, Courbevoie, France. Sintered bauxite ceramic proppants are available, for example, from Borovichi Refractories, Borovichi, Russia; 3M Company, St. Paul, Minn.; CarboCeramics; and Saint Gobain. Glass bubble and bead proppants are available, for example, from Diversified Industries, Sidney, British Columbia, Canada; and 3M Company.

Bauxite proppants have been reported in the art to be difficult to treat (e.g., in a hydrocarbon-bearing formation) with chemical treatments in order to improve the conductivity of a fracture; (see, e.g., Bang, V., “Development of a Successful Chemical Treatment for Gas Wells with Condensate or Water Blocking Damage” (Thesis), December 2007, pp. 267-268). The data in the examples, below, show that the methods disclosed herein are useful for treating bauxite proppants and for improving the conductivity of fractures containing bauxite proppants. In some embodiments of the methods and hydrocarbon-bearing formations disclosed herein, wherein the hydrocarbon-bearing formation has at least one fracture and a plurality of proppants therein, the formation and/or plurality of proppants are treated with a polymeric fluorinated epoxide comprising a first divalent unit represented by formula III, a second divalent unit comprising a pendent epoxide, and a polyalkyleneoxy segment.

In some embodiments, the proppants form packs within a formation and/or wellbore. Proppants may be selected to be chemically compatible with the solvents and compositions described herein. The term “proppant” as used herein includes fracture proppant materials introducible into the formation as part of a hydraulic fracture treatment and sand control particulate introducible into the wellbore/formation as part of a sand control treatment such as a gravel pack or frac pack.

In some embodiments, methods according to the present disclosure include treating the hydrocarbon-bearing formation with the fluorinated epoxide at least one of during fracturing or after fracturing the hydrocarbon-bearing formation.

In some embodiments of methods of treating fractured formations, the amount of the fluorinated epoxide or a composition comprising the fluorinated epoxide introduced into the fractured formation (i.e., after fracturing) is based at least partially on the volume of the fracture(s). The volume of a fracture can be measured using methods that are known in the art (e.g., by pressure transient testing of a fractured well). Typically, when a fracture is created in a hydrocarbon-bearing subterranean formation, the volume of the fracture can be estimated using at least one of the known volume of fracturing fluid or the known amount of proppant used during the fracturing operation. Coil tubing, for example, may be used to deliver the fluorinated epoxide to a particular fracture. In some embodiments, in practicing the methods disclosed herein it may be desirable to isolate the fracture (e.g., with conventional packers) to be treated with the fluorinated epoxide.

In some embodiments, wherein the formation treated according to the methods described herein has at least one fracture, the fracture has a conductivity, and after the fluorinated epoxide treats at least one of the fracture or at least a portion of the plurality of proppants, the conductivity of the fracture is increased (e.g., by 25, 50, 75, 100, 125, 150, 175, 200, 225, 250, 275, or even by 300 percent). In some embodiments, the fractured hydrocarbon-bearing formation has a fracture with a conductivity, wherein treating the proppants with the fluorinated epoxide provides an increase in the conductivity of the fracture (e.g., by 25, 50, 75, 100, 125, 150, 175, 200, 225, 250, 275, or even by 300 percent).

In some embodiments of treated particles (e.g., proppants) according to the present disclosure, these particles collectively have particles in a range from 100 micrometers to 3000 micrometers (i.e., about 140 mesh to about 5 mesh (ANSI)) (in some embodiments, in a range from 1000 micrometers to 3000 micrometers, 1000 micrometers to 2000 micrometers, 1000 micrometers to 1700 micrometers (i.e., about 18 mesh to about 12 mesh), 850 micrometers to 1700 micrometers (i.e., about 20 mesh to about 12 mesh), 850 micrometers to 1200 micrometers (i.e., about 20 mesh to about 16 mesh), 600 micrometers to 1200 micrometers (i.e., about 30 mesh to about 16 mesh), 425 micrometers to 850 micrometers (i.e., about 40 to about 20 mesh), or 300 micrometers to 600 micrometers (i.e., about 50 mesh to about 30 mesh).

Typically for making treated particles (e.g., proppants) according to the present disclosure, the fluorinated epoxide is dissolved or dispersed in a dispersing medium (e.g., water and/or organic solvent (e.g., alcohols, ketones, esters, alkanes and/or fluorinated solvents (e.g., hydrofluoroethers and/or perfluorinated carbons)) that is then applied to the particles. Optionally, a Lewis Acid catalyst can be added (e.g., complexes of boron trifluoride such as boron trifluoride etherate, boron trifluoride tetrahydropyran, and boron trifluoride tetrahydrofuran; phosphorous pentafluoride, antimony pentafluoride, zinc chloride, aluminum bromide, or (CF₃SO₂)₂CH₂). Under these conditions, the fluorinated epoxide may polymerize. The amount of liquid medium used should be sufficient to allow the solution or dispersion to generally evenly wet the particles being treated. Typically, the concentration of the fluorinated epoxide in the solution/dispersion solvent is the range from about 5% to about 20% by weight, although amounts outside of this range may also be useful. The particles are typically treated with the fluorinated epoxide solution/dispersion at temperatures in the range from about 25° C. to about 50° C., although temperatures outside of this range may also be useful. The treatment solution/dispersion can be applied to the particles using techniques known in the art for applying solutions/dispersions to particles (e.g., mixing the solution/dispersion and particles in a vessel (in some embodiments under reduced pressure) or spraying the solutions/dispersions onto the particles). After application of the treatment solution/dispersion to the particles, the liquid medium can be removed using techniques known in the art (e.g., drying the particles in an oven). Typically, about 0.1 to about 5 (in some embodiments, for example, about 0.5 to about 2) percent by weight fluorinated epoxide is added to the particles, although amounts outside of this range may also be useful.

For methods of fracturing a hydrocarbon-bearing formation according to the present disclosure, the hydraulic fluid and/or the fluid comprising the plurality of proppants may be aqueous (e.g., a brine) or may contain predominantly organic solvent (e.g., an alcohol or a hydrocarbon). In some embodiments, it may be desirable for one or both of the fluids to include contain viscosity enhancing agents (e.g., polymeric viscosifiers), electrolytes, corrosion inhibitors, scale inhibitors, and other such additives that are common to a fracturing fluid.

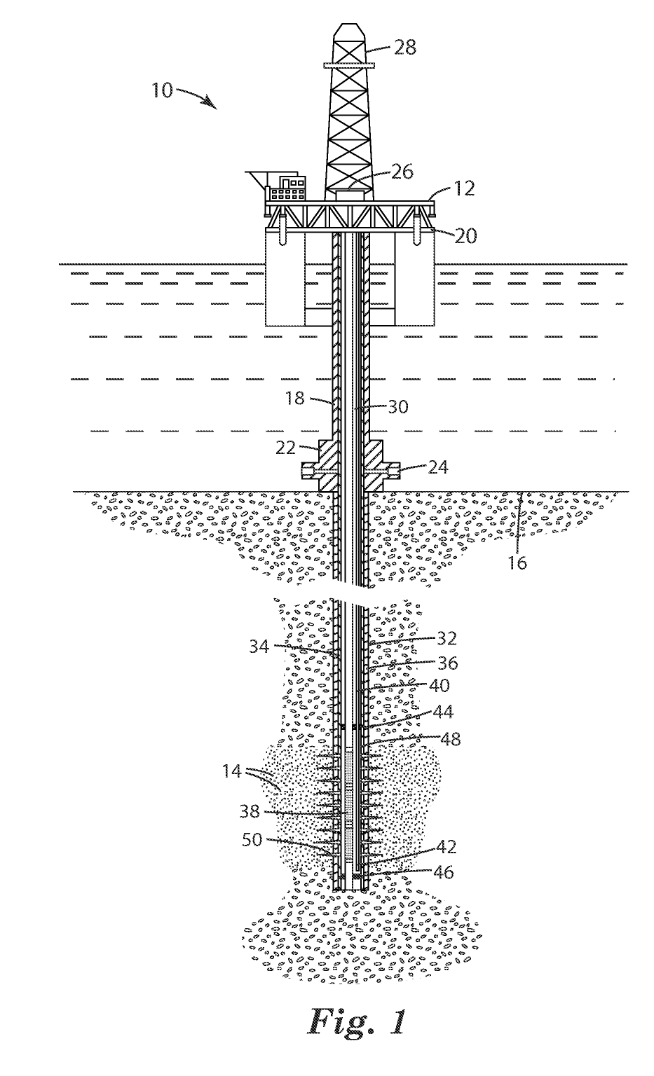

Referring to FIG. 1, an exemplary offshore oil platform is schematically illustrated and generally designated 10. Semi-submersible platform 12 is centered over submerged hydrocarbon-bearing formation 14 located below sea floor 16. Subsea conduit 18 extends from deck 20 of platform 12 to wellhead installation 22 including blowout preventers 24. Platform 12 is shown with hoisting apparatus 26 and derrick 28 for raising and lowering pipe strings such as work string 30.

Wellbore 32 extends through the various earth strata including hydrocarbon-bearing formation 14. Casing 34 is cemented within wellbore 32 by cement 36. Work string 30 may include various tools including, for example, sand control screen assembly 38 which is positioned within wellbore 32 adjacent to hydrocarbon-bearing formation 14. Also extending from platform 12 through wellbore 32 is fluid delivery tube 40 having fluid or gas discharge section 42 positioned adjacent to hydrocarbon-bearing formation 14, shown with production zone 48 between packers 44, 46. When it is desired to treat the near-wellbore region of hydrocarbon-bearing formation 14 adjacent to production zone 48, work string 30 and fluid delivery tube 40 are lowered through casing 34 until sand control screen assembly 38 and fluid discharge section 42 are positioned adjacent to the near-wellbore region of hydrocarbon-bearing formation 14 including perforations 50. Thereafter, a composition described herein is pumped down delivery tube 40 to progressively treat the near-wellbore region of hydrocarbon-bearing formation 14.

While the drawing depicts an offshore operation, the skilled artisan will recognize that the methods for treating a production zone of a wellbore are equally well-suited for use in onshore operations. Also, while the drawing depicts a vertical well, the skilled artisan will also recognize that methods according to the present disclosure are equally well-suited for use in deviated wells, inclined wells or horizontal wells.

### EXAMPLES

(2,2,3,3,4,4,5,5,6,6,7,7,8,8,9,9,9-Heptadecafluorononyl)oxirane, dopamine hydrochloride, glycidyl methacrylate, carbon tetrabromide, and poly(ethylene glycol)methyl ether methacrylate were obtained from Sigma-Aldrich, St. Louis, Mo.

### Preparation of N-methyl-N-(oxiran-2-ylmethyl)perfluorobutanesulfonamide-1

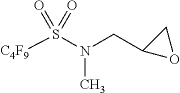

A fluoroaliphatic-sulfonamide was prepared as described in Example 2 of U.S. Pat. No. 4,533,713 (Howells), except that an equimolar amount of C₈F₁₇SO₂NH₂ was substituted with C₄F₉SO₂NHCH₃. The C₄F₉SO₂NHCH₃ was prepared as described in Example 1, Step A of U.S. Pat. No. 6,664,354 (Savu et al.). After completion of the reaction, the resulting mixture was submitted to vacuum distillation thus obtaining a colorless liquid with a boiling point of 100-105° C. at a pressure of 0.3 mmHg (40 Pa). From GC-MS analysis, the following components were identified, with the reported amounts based on GC-FID area %.

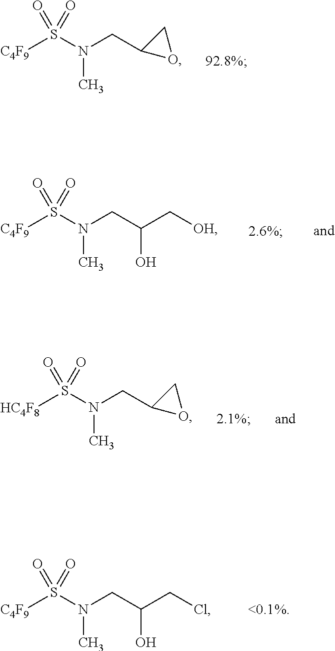

### Preparation of N-methyl-N-(oxiran-2-ylmethyl)perfluorobutanesulfonamide-2

The procedure for the preparation of N-methyl-N-(oxiran-2-ylmethyl)perfluorobutanesulfonamide-1 was repeated to provide an isolated product having the following components, which were identified using GC/MS. The reported amounts, below, are based on GC-FID area %.

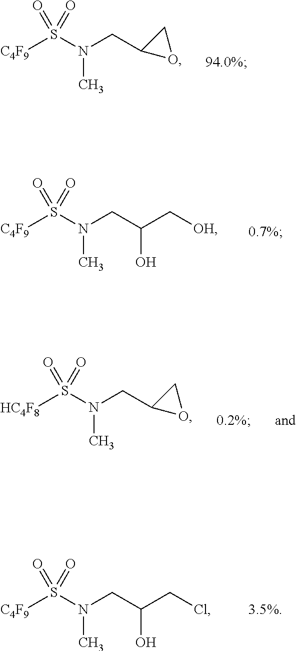

Preparation of Epoxide Oligomer

Part A. F(CF(CF₃)CF₂O)ₐCF(CF₃)—C(O)N(H)CH₂CH₂OC(O)CMe=CH₂ (HFPO-MAr, average molecular weight 1344) was prepared using the procedure described in U.S. Pat. No. 7,094,829 (Audenaert et al.), except that an equimolar amount of F(CF(CF₃)CF₂O)ₐCF(CF₃)C(O)NHCH₂CH₂OH with a=6.8 was substituted for F(CF(CF₃)CF₂O)ₐCF(CF₃)C(O)NHCH₂CH₂OH with a=10.5.

In a 440-mL (16-ounce) flask fitted with a magnetic stir bar, were placed 0.0149 mol (20.03 grams) of HFPO-MAr, 0.0762 mol (10.04 grams) of glycidyl methacrylate, 0.0668 mol (20.06 grams) of poly(ethylene glycol) methyl ether methacrylate, 0.0015 mol (0.50 gram) of carbon tetrabromide, 150.36 grams ethyl acetate, and 1.01 gram of a free radical initiator obtained from E. I. DuPont de Nemours, Wilmington, Del., under the trade designation “VAZO-67”. The mixture was stirred for 24 hours at 70° C. under nitrogen. A clear liquid was obtained. Using FTIR spectroscopy, almost no CH₂═CMe-signal was observed.

Core Flood Setup:

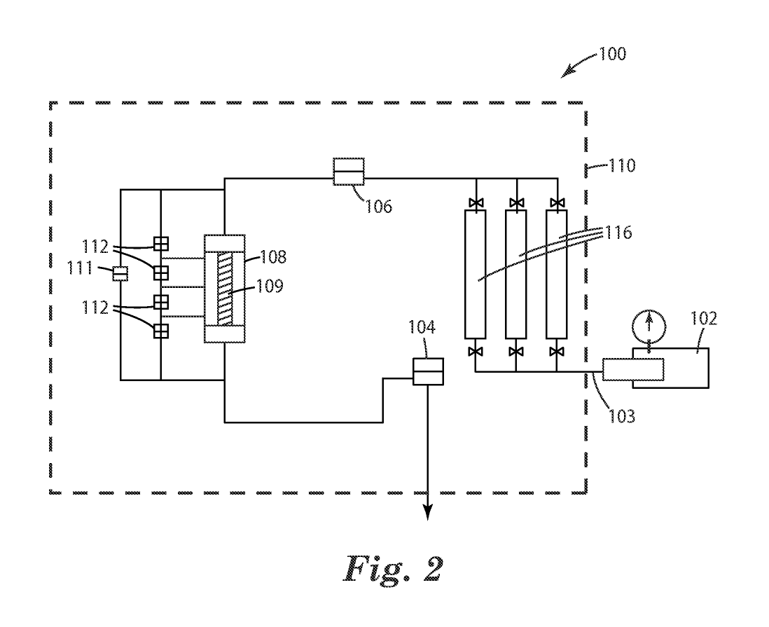

A schematic diagram of a core flood apparatus 100 used to determine relative permeability of a substrate sample (i.e., core) is shown in FIG. 2. Core flood apparatus 100 included positive displacement pumps (Quizix Model 6000 QX; obtained from Chandler Engineering 102 to inject fluid 103 at constant rate into fluid accumulators 116. Multiple pressure ports 112 on high-pressure core holder 108 (Hassler-type Model UTPT-1x8-3K-13 obtained from Phoenix, Houston Tex.) were used to measure pressure drop across four sections (2 inches (5.1 cm) in length each) of core 109. An additional pressure port 111 on core holder 108 was used to measure pressure drop across the entire length (8 inches (20.3 cm)) of core 109. Two back-pressure regulators (Model No. BPR-50; obtained from Temco, Tulsa, Okla.) 104, 106 were used to control the flowing pressure upstream 106 and downstream 104 of core 109.

The flow of fluid was through a vertical core to avoid gravity segregation of the gas. High-pressure core holder 108, back pressure regulators 104 and 106, fluid accumulators 116, and tubing were placed inside a pressure- and temperature-controlled oven 110 (Model DC 1406F; maximum temperature rating of 650° F. (343° C.) obtained from SPX Corporation, Williamsport, Pa.). The maximum flow rate of fluid was 7,000 mL/hr. An overburden pressure of 3400 psig (2.3×10⁷ Pa) was applied.

Cores:

Core samples used for each Example were cut from a sandstone block obtained from Cleveland Quarries, Vermillion, Ohio, under the trade designation “BEREA SANDSTONE” or a Texas Cream Limestone block obtained from Texas Quarries, Round Rock, Tex. The properties for the core used for each of Examples 1 to 6 are shown in Table 1, below.

TABLE 1

| | Example | Example | Example | Example | Example | Example |
|---|---|---|---|---|---|---|
| | 1 | 2 | 3 | 4 | 5 | 6 |
| Core | Berea | Berea | Texas | Texas | Texas | Texas |
| | | | Cream | Cream | Cream | Cream |
| Diameter, | 1 (2.54) | 1 (2.54) | 1 (2.54) | 1 (2.54) | 1 (2.54) | 1 (2.54) |
| inch (cm) | | | | | | |
| Length, | 8 (20.3) | 8 (20.3) | 8 (20.3) | 8 (20.3) | 6.7 (17) | 8 (20.3) |
| inch (cm) | | | | | | |
| Pore | 17.8 | 21.5 | 20 | 20 | 20 | 20 |
| volume, mL | | | | | | |
| Porosity, % | 17.8 | 20.7 | 20.8 | 20.8 | 17.2 | 20.8 |
| Perme- | 178 | 183 | 14.4 | 175 | 14.7 | 19.4 |
| ability (md) | | | | | | |

The porosity was determined from the measured mass of the dry core, the bulk volume of the core, and the grain density of quartz. The pore volume is the product of the bulk volume and the porosity.

Synthetic Gas-Condensate Fluids

Three synthetic gas-condensate fluids and one volatile oil fluid were prepared for the core flood evaluations. The components and their amounts in each of the synthetic fluids are shown in Table 2, below.

TABLE 2

| | Synthetic | Synthetic | Synthetic | Synthetic |
|---|---|---|---|---|
| | Fluid 1 | Fluid 2 | Fluid 3 | Fluid 4 |
| Methane | 89 mole % | 86 mole % | 86 mole % | 75 mole % |
| Ethane | — | 6 mole % | — | — |
| Propane | 5 mole % | — | 6 mole % | 12 mole % |
| n-Heptane | 2.5 mole % | 5 mole % | 5 mole % | 9 mole % |
| n-Decane | 2.5 mole % | 3 mole % | 3 mole % | 4 mole % |
| n-Pentadecane | 1 mole % | — | — | — |

### Example 1

The core described in Table 1, above, was dried for 24 hours in a standard laboratory oven at 180° C. and then wrapped in aluminum foil and heat shrink tubing (obtained under the trade designation “TEFLON HEAT SHRINK TUBING” from Zeus, Inc., Orangeburg, S.C.). Referring again to FIG. 2, the wrapped core 109 was placed in core holder 108 inside oven 110 at 75° F. (24° C.).

Initial permeability of the core was measured at flow rates of 1500 to 6000 cc/hr using nitrogen at 75° F. (24° C.) and was determined to be 178 md. The temperature of the oven was then raised to 175° F. (79° C.).

Brine (30,000 ppm sodium chloride) was introduced into the core 109 by the following procedure. The outlet end of the core holder was connected to a vacuum pump and a full vacuum was applied for 30 minutes with the inlet closed. The inlet was connected to a burette with the brine in it. The outlet was closed and the inlet was opened to allow 4.3 mL of brine to flow into the core, and the inlet value was closed to establish a brine saturation of 19%. The permeability was measured at the brine saturation of 19% by flowing nitrogen gas at 1000 psig (6.8×10⁶ Pa) and 75° F. (20° C.). The results are shown in Table 3, below.

Following the measurement of the nitrogen gas permeability at the brine saturation of 19%, the pressure of the core was dropped to 500 psig (3.4×10⁶ Pa), and the temperature of the oven 110 was raised to 175° F. (79° C.). The wrapped core 109 in the oven 110 was maintained at 175° F. (79° C.) for 12 hours.

An initial two-phase flood was conducted using Synthetic Fluid 1, shown in Table 2 (above), with the upstream back-pressure regulator 106 set at 5100 psig (3.5×10⁷ Pa), above the dew point pressure of the fluid, and downstream back-pressure regulator 104 was set at about 500 psig (3.4×10⁶ Pa). The flow rate shown in Table 3, below, was used. After a steady state was established, the gas relative permeability before treatment was then calculated from the steady state pressure drop. The gas relative permeability (k_{rg}) calculated from the initial two-phase flood is shown in Table 3, below.

TABLE 3

| | Example | Example | Example | Example | Example | Example |
|---|---|---|---|---|---|---|
| | 1 | 2 | 3 | 4 | 5 | 6 |
| kg, md | 178 | 183 | 14.4 | 23.9 | 14.7 | 19.4 |
| Temperature, | 175 (79) | 175 (79) | 175 (79) | 175 (79) | 175 (79) | 275 (135) |
| ° F. (° C.) | | | | | | |
| S_{wi}, % | 19 | 19 | 0 | 25 | 25 | 25 |
| Salinity, ppm | 30,000 | 30,000 | 0 | 30,000 | 30,000 | 30,000 |
| Core | 500 | 500 | 1200 | 1200 | 1200 | 1500 |
| Pressure, psi | (3.4 × 10⁶) | (3.4 × 10⁶) | (8.3 × 10⁶) | (8.3 × 10⁶) | (8.3 × 10⁶) | (1.0 × 10⁷) |
| (Pa) | | | | | | |
| Synthetic | Synthetic | Synthetic | Synthetic | Synthetic | Synthetic | Synthetic |
| Fluid Used | Fluid 1 | Fluid 1 | Fluid 2 | Fluid 2 | Fluid 2 | Fluid 2 |
| Liquid | 1.5 | 1.5 | 5 | 5 | 5 | 3 |
| dropout, % | | | | | | |
| Pretreatment | no | dopamine | no | isopropanol | dopamine | isopropanol |
| Capillary # | 1.26 × 10⁻⁵ | 1.35 × 10⁻⁵ | 4.8 × 10⁻⁶ | 5.9 × 10⁻⁶ | 5.9 × 10⁻⁶ | 4.8 × 10⁻⁶ |
| k_{rg} before | 0.061 | 0.068 | 0.093 | 0.078 | 0.068 | 0.153 |
| treatment | | | | | | |
| k_{rg} after | 0.134 | 0.125 | 0.133 | 0.131 | 0.124 | 0.156 |
| treatment | | | | | | |
| k_{rg}/kᵣₒ | 1.95 | 2.4 | 1.45 | 1.45 | 1.5 | 4.25 |
| Initial | 2.19 | 1.84 | 1.4 | 1.7-1.6 | 1.82 | 1.0 |
| Improvement | | | | | | |
| Factor | | | | | | |

A treatment composition was prepared by combining (2,2,3,3,4,4,5,5,6,6,7,7,8,8,9,9,9-heptadecafluorononyl)oxirane and isopropanol to make 400 grams of a 2% by weight solution of the (heptadecafluorononyl)oxirane. The components were mixed together using a magnetic stirrer and magnetic stir bar.

The treatment composition was then injected into the core for 20 pore volumes at a rate of 100 mL/hour. The composition was then held in the core at 175° F. (79° C.) for about 15 hours. A post-treatment two-phase flood was then conducted using the same conditions as the initial two-phase flood. After a steady state was established (704 pore volumes), the gas relative permeability after treatment was then calculated from the steady state pressure drop. The improvement factor is the k_{rg} after treatment divided by the k_{rg} before treatment. The results are shown in Table 3, above.

Additional two-phase floods were then conducted, resulting in the injection of 2800 pore volumes over a period of 5 days. The gas relative permeability and resulting improvement factors were calculated from the steady state pressure drop after the time periods and total pore volumes shown in Table 4, below.

TABLE 4

| | Total Pore volumes Synthetic | |
|---|---|---|
| Days elapsed | Fluid 1 | Improvement Factor |
| 0 | 704 | 2.19 |
| 1 | 1240 | 1.79 |
| 2 | 1778 | 1.62 |
| 3 | 2302 | 1.72 |
| 5 | 2807 | 1.63 |

Following the relative permeability measurements, methane gas was injected, using positive displacement pump 102, to displace Synthetic Fluid 1 and measure the final single-phase gas permeability.

### Example 2

Example 2 was carried out using the method of Example 1 except with the following modifications. After the initial two-phase gas-condensate flood, a 0.2% by weight solution of dopamine and sodium bicarbonate added to adjust the pH to 8.5 in water was injected for 5 pore volumes. The solution was then held in the core at 175° F. (79° C.) for 12 hours before the injection of the treatment solution. During the first post-treatment two-phase gas-condensate flood 464 pore volumes of Synthetic Fluid 1 were injected, and the improvement factor shown in Table 3 was calculated. Additional two-phase gas-condensate floods were carried out and improvement factors were calculated as shown in Table 5, below.

TABLE 5

| | Total Pore volumes Synthetic | |
|---|---|---|
| Days elapsed | Fluid 1 | Improvement Factor |
| 0 | 464 | 1.84 |
| 1 | 940 | 1.51 |
| 2 | 1419 | 1.46 |

### Example 3

Example 3 was carried out using the method of Example 1 except with the following modifications and using the materials and conditions given in Tables 1, 2, and 3, above. No initial water saturation procedure was used. The treatment composition was a 1% by weight solution of (2,2,3,3,4,4,5,5,6,6,7,7,8,8,9,9,9-heptadecafluorononyl) oxirane in isopropanol. During the first post-treatment two-phase gas-condensate flood about 100 pore volumes of Synthetic Fluid 2 were injected, and the improvement factor shown in Table 3 was calculated. The treatment composition was then reinjected for 20 pore volumes, and a second post-treatment two-phase gas condensate flood was carried out for about 100 pore volumes. The gas relative permeability and improvement factor calculated after the second post-treatment two-phase gas condensate flood were 0.13 and 1.36 respectively.

### Example 4

Example 4 was carried out using the method of Example 1 except with the following modifications and using the materials and conditions given in Tables 1, 2, and 3, above. After the treatment composition was injected it was shut in the core overnight (about 15 hours). During the first post-treatment two-phase gas-condensate flood about 100 pore volumes of Synthetic Fluid 2 were injected, and the improvement factor shown in Table 3 was calculated. The core was allowed to stand for 48 hours, and then another post-treatment two-phase gas-condensate flood was run for about 140 pore volumes, providing an improvement factor of 1.1.

### Example 5

Example 5 was carried out using the method of Example 1 except with the following modifications and using the materials and conditions given in Tables 1, 2, and 3, above. After the initial two-phase gas-condensate flood, a 0.2% by weight solution of dopamine and sodium bicarbonate in water to adjust the pH to 8.5, prepared as described in Example 2, was injected for 5 pore volumes. The solution was then held in the core at 175° F. (79° C.) for 12 hours before the injection of the treatment solution. During the first post-treatment two-phase gas-condensate flood 200 pore volumes of Synthetic Fluid 2 were injected, and the improvement factor shown in Table 3, above, and Table 6, below, was calculated. Additional two-phase gas-condensate floods were carried out, resulting in 1161 pore volumes injected over a period of 2 weeks, and improvement factors were calculated as shown in Table 6, below.

TABLE 6

| | Total Pore volumes Synthetic | |
|---|---|---|
| Days elapsed | Fluid 2 | Improvement Factor |
| 0 | 200 | 1.82 |
| 1 | 400 | 1.71 |
| 2 | 590 | 1.61 |
| 3 | 783 | 1.59 |
| 4 | 964 | 1.67 |
| 7 | 1161 | 1.59 |

### Example 6

Example 6 was carried out using the method of Example 1 except with the following modifications and using the materials and conditions given in Tables 1, 2, and 3, above. After the treatment composition was injected it was shut in the core overnight (about 15 hours). During the first post-treatment two-phase gas-condensate flood about 100 pore volumes of Synthetic Fluid 2 were injected, and the improvement factor shown in Table 3 was calculated.

### Examples 7 and 8

Fractured Core Preparation. A 1 inch (2.5 cm) diameter Berea core plug was sawed in half longitudinally and then put in a standard laboratory oven to dry overnight at 150° C. One half of the rock was rested on the lab bench and two long spacers were laid on top of it with the ends protruding beyond one end of the core and flush with the other. The other half was placed on top. The core was then wrapped with polytetrafluoroethylene (PTFE) tape. The resulting fracture space was the width of the spacers (0.22 cm). For Examples 7 and 8, the void was then filled with sand (obtained from US Silica, under the trade designation “OTTAWA F35”) having an average mesh size of about 35 corresponding to an average grain diameter of on the order of 0.04 cm. The core was lightly tapped to distribute the proppant throughout the fracture space and then the spacers were slowly pulled out as the sand filled the void. The fractured rock was wrapped with aluminum foil and shrink wrapped with heat shrink tubing (obtained under the trade designation “TEFLON HEAT SHRINK TUBING” from Zeus, Inc.) and then loaded into core holder 108 with a 1 inch (2.5 cm) sleeve.

Properties of the fracture are given in Table 7, below. Initial permeability of the fracture was measured using nitrogen or methane.

TABLE 7

| | |
|---|---|
| Aperture | 0.24 cm |
| Length | 8 inches (20.3 cm) |
| Porosity | 37% |
| pore volume | 4.4 cc |

Core Flooding Procedure. The core flooding procedure was carried out using the method of Example 1. For Example 7, the treatment composition described in Example 1 was used. For Example 8, the pretreatment and treatment compositions described in Example 2 were used. High flow rates, with velocities ranging from about 0.3 cm/second to about 1.5 cm/second were used. The results are shown in Table 8, below.

TABLE 8

| | | Core Pressure, | | |
|---|---|---|---|---|
| Example | Treatment | psi (Pa) | k_{rg}/kᵣₒ | k_{rg} |
| | none | 1000 (6.8 × 10⁶) | 1.29 | 0.117 |
| Example 7 | Epoxide | 500 (3.4 × 10⁶) | 1.22 | 0.336 |
| Example 8 | Dopamine then | 500 (3.4 × 10⁶) | 1.22 | 0.428 |
| | Epoxide | | | |

### Example 9

Example 9 was carried out using the method of Example 8, except with the following modifications. Bauxite proppant (obtained from Sintex Minerals and Services, Inc., Houston, Tex., under the trade designation “SINTEX 30/50”) was used instead of the Ottawa sand. The results are shown in Table 9, below, where velocities ranging from about 0.5 cm/second to about 4 cm/second were used for Example 9, and velocities ranging from 0.3 cm/second to 4.5 cm/second were used for the untreated sample.

TABLE 9

| | Temperature | | Core Pressure, | | |
|---|---|---|---|---|---|
| Example | ° F. (° C.) | Treatment | psi (Pa) | k_{rg}/kᵣₒ | k_{rg} |
| | 275 (135) | none | 1500 (1.0 × 10⁷) | 3.88 | 0.153 |
| Example 9 | 175 (79) | Dopamine | 500 (3.4 × 10⁶) | 1.22 | 0.223 |
| | | then | | | |
| | | Epoxide | | | |

Cores: Core samples used for each of Examples 10 to 19 were cut from a sandstone block obtained from Cleveland Quarries under the trade designation “BEREA SANDSTONE” or a Texas Cream Limestone block obtained from Texas Quarries. The porosity and pore volume were determined as described above for Examples 1 to 6. The properties for the core used for each of Examples 10 to 19 are shown in Table 10, below.

TABLE 10

| | | | | Pore | | Perme- |
|---|---|---|---|---|---|---|
| | | Diameter, | Length, | Volume, | Porosity, | ability, |
| | Core | inch (cm) | inch (cm) | mL | % | md |
| Ex. 10 | Texas | 1 (2.54) | 8 (20.3) | 20.1 | 20 | 11 |
| | Cream | | | | | |
| Ex. 11 | Texas | 1 (2.54) | 8 (20.3) | 20 | 20 | 18.5 |
| | Cream | | | | | |
| Ex. 12 | Texas | 1 (2.54) | 8 (20.3) | 20 | 20.75 | 23.5 |
| | Cream | | | | | |
| Ex. 13 | Texas | 1 (2.54) | 8 (20.3) | 25.1 | 25.8 | 19.6 |
| | Cream | | | | | |
| Ex. 14 | Texas | 1 (2.54) | 8 (20.3) | 27.12 | 25.8 | 13.8 |
| | Cream | | | | | |
| Ex. 15 | Texas | 1 (2.54) | 8 (20.3) | 23.4 | 20.7 | 3.3 |
| | Cream | | | | | |
| Ex. 16 | Texas | 1 (2.54) | 8 (20.3) | 23.7 | 22.4 | 5.7 |
| | Cream | | | | | |
| Ex. 17 | Texas | 1 (2.54) | 8 (20.3) | 23.1 | 23.4 | 4.6 |
| | Cream | | | | | |
| Ex. 18 | Berea | 1 (2.54) | 8 (20.3) | 20.4 | 19.8 | 189 |
| Ex. 19 | Berea | 1 (2.54) | 8 (20.3) | 20.8 | 20.2 | 145 |

### Example 10

Example 10 was carried out using the method and conditions of Example 5 except with the following modifications. After the dopamine solution was injected, a permeability of 7.3 md was measured. The treatment composition was prepared by combining N-methyl-N-(oxiran-2-ylmethyl)perfluorobutanesulfonamide-1 and a 95/5 (w/w) solution of isopropanol and water to make 400 grams of a 2% by weight solution of the epoxide. After the treatment composition was injected, a permeability of 9.4 md was measured. During the first post-treatment two-phase gas-condensate flood approximately 50 pore volumes of Synthetic Fluid 3 were injected at two different flow rates, and the gas relative permeability and initial improvement factor shown in Table 11, below, were calculated. Three additional post-treatment two-phase gas-condensate floods using a total of approximately 400 pore volumes of Synthetic Fluid 3 were carried out, and a final improvement factor of 1.4 was calculated for each flow rate. After the final methane injection of 400 pore volumes, a final permeability of 9.4 md was measured.

TABLE 11

| | | | | k_{rg} | k_{rg} | | |
|---|---|---|---|---|---|---|---|
| | Flow | | | before | after | | Initial |
| | rate | Cap- | | treat- | treat- | | Improvement |
| | mL/hour | illary # | | ment | ment | k_{rg}/kᵣₒ | Factor |
| Ex. 10 | 100 | 4.3 | E−6 | 0.088 | 0.146 | 1.4 | 1.67 |
| | 200 | 8.43 | E−6 | 0.089 | 0.143 | 1.4 | 1.62 |
| Ex. 11 | 100 | 4.8 | E−6 | 0.079 | 0.13 | 1.4 | 1.64 |
| | 200 | 8.8 | E−6 | 0.087 | 0.13 | 1.4 | 1.51 |
| Ex. 13 | 350 | 3.73 | E−6 | 0.095 | 0.162 | 1.3 | 1.76 |
| | 700 | 7.45 | E−6 | 0.104 | 0.153 | 1.3 | 1.5 |
| Ex. 14 | 150 | 4.87 | E−6 | 0.073 | 0.259 | 1.3 | 3.6 |
| | 450 | 6.62 | E−6 | 0.077 | 0.202 | 1.3 | 2.8 |
| Ex. 15 | 125 | 2.14 | E−6 | 0.069 | 0.121 | 1.25 | 1.76 |
| Ex. 16 | 260 | 3.78 | E−6 | 0.138 | 0.169 | 2.0 | 1.2 |
| Ex. 17 | 260 | 3.1 | E−6 | 0.148 | 0.23 | 2.0 | 1.6 |
| Ex. 18 | 125 | not | | 0.038 | 0.076 | 1.1 | 2.6 (1200 psi) |
| | 125 | reported | | 0.041 | 0.075 | 0.097 | 1.7 (700 psi) |
| | 250 | Not | | 0.035 | 0.063 | 1.1 | 1.7 (1200 psi) |
| | 250 | reported | | 0.039 | 0.055 | 0.098 | 1.4 (700 psi) |
| Ex. 19 | 150 | 4.1 | E−6 | 0.031 | 0.075 | 0.77 | 2.5 |

### Example 11

Example 11 was carried out using the method and conditions of Example 4 except with the following modifications. The treatment composition was prepared by combining N-methyl-N-(oxiran-2-ylmethyl)perfluorobutanesulfonamide-1 and a 95/5 (w/w) solution of isopropanol and water to make 400 grams of a 2% by weight solution of the epoxide. After the treatment composition was injected, a permeability of 10.4 and was measured. During the first post-treatment two-phase gas-condensate flood approximately 50 pore volumes of Synthetic Fluid 3 were injected at two different flow rates, and the gas relative permeability and initial improvement factor shown in Table 11, above, were calculated. Four additional second post-treatment two-phase gas-condensate floods using a total of approximately 250 pore volumes of Synthetic Fluid 3 were carried out, and a final improvement factor of 1.3 was calculated for each flow rate. After the final methane injection of 140 pore volumes, a final permeability of 16.8 and was measured.

### Example 12

The core described in Table 10 was prepared as described in Example 1. After the oven temperature was raised to 175° F. (79° C.) one pore volume of brine having a composition of 30,000 ppm sodium chloride and 200 ppm calcium chloride was injected into the core, methane was injected into the core at flow rates of 128.5, 257, 514, and 1028 mL/hour, with 25 pore volumes injected at each flow rate, and k_{rg} was measured from the last pressure drop for each flow rate. The results are shown in Table 12, below. A treatment composition was prepared by combining N-methyl-N-(oxiran-2-ylmethyl)perfluorobutanesulfonamide-1 and a 95/5 (w/w) solution of isopropanol and water to make 400 grams of a 2% by weight solution of the epoxide. This treatment composition was used to treat the core using the procedure described in Example 1; 15 pore volumes were injected. Methane was injected for a number of pore volumes sufficient to displace the solvents from the treatment composition from the core, and then one pore volume of the brine was again injected into the core. Methane was injected into the core at the flow rates mentioned above, and k_{rg} was measured from the last pressure drop for each flow rate. The results are shown in Table 12, below. The temperature of the oven was then increased to 275° F. (135° C.), and then one pore volume of the brine was again injected into the core. Methane was injected into the core at the flow rates mentioned above, and k_{rg} was measured from the last pressure drop for each flow rate. The improvement factor remained the same as that shown in Table 12, below.

TABLE 12

| Methane flow rate, | k_{rg} Before | k_{rg} After | |
|---|---|---|---|
| mL/hour | Treatment | Treatment | Improvement Factor |
| 128.5 | 0.20 | 0.45 | 2.2 |
| 257 | 0.28 | 0.55 | 2.0 |
| 514 | 0.34 | 0.56 | 1.6 |
| 1028 | 0.39 | 0.55 | 1.4 |

### Example 13

Example 13 was carried out using the methods and conditions of Example 3 except with the following modifications. A core pressure of 1000 psi (6.8×10⁶ Pa) was used. The treatment composition was prepared by combining the Epoxide Oligomer described above and a 70/30 (w/w) solution of 2-butoxyethanol and ethanol to make 400 grams of a 2% by weight solution of the Epoxide Oligomer. Three post-treatment two-phase core floods were carried out with a total of 250 pore volumes of Synthetic Fluid 3 at two different flow rates: 350 mL/hour and 700 mL/hour. The improvement factor did not change significantly throughout the three core floods. The k_{rg} values and initial improvement factors obtained at the two flow rates are shown in Table 11, above.

### Example 14

Example 14 was carried out using the methods and conditions of Example 13 except three post-treatment two-phase core floods were carried out with a total of 150 pore volumes of Synthetic Fluid 3 at two different flow rates: 150 mL/hour and 450 mL/hour. The improvement factor did not change significantly throughout the three core floods. The initial k_{rg} values and initial improvement factors obtained at the two flow rates are shown in Table 11, above.

### Example 15

Example 15 was carried out using the methods and conditions of Example 13 except five post-treatment two-phase core floods were carried out with a total of 220 pore volumes of Synthetic

Fluid 3. The first post-treatment core flood was carried out at a flow rate of 125 mL/hour, and subsequent core floods were carried out at a flow rate of 160 mL/hour. The improvement factor did not change significantly throughout the three core floods. The k_{rg} values and initial improvement factors obtained are shown in Table 11, above.

### Example 16

Example 16 was carried out using the methods and conditions of Example 13 except the oven temperature was 275° F. (135° C.), and one post-treatment two-phase core flood was carried out with a total of 100 pore volumes of Synthetic Fluid 3 at a flow rate of 260 mL/hour. The k_{rg} values and improvement factor obtained are shown in Table 11, above.

### Example 17

Example 17 was carried out using the methods and conditions of Example 16 by retreating the core from Example 16 with the Fluorinated Oligomer solution. The k_{rg} values and initial improvement factor obtained are shown in Table 11, above. Additional post-treatment two-phase core flooding resulted in an improvement factor of 1.0.

### Example 18

Example 18 was carried out using the methods and conditions of Example 3 with the core described in Table 10, but with the following modifications. An oven temperature of 155° F. (68° C.) was used. The treatment composition was prepared by combining the Epoxide Oligomer described above and a 70/30 (w/w) solution of 2-butoxyethanol/ethanol to make 400 grams of a 2% by weight solution of the Epoxide Oligomer. Three post-treatment two-phase core floods were carried out with a total of 1300 pore volumes of Synthetic Fluid 3 at two different flow rates: 250 mL/hour and 125 mL/hour. The k_{rg} values and initial improvement factors obtained after 200 pore volumes were injected are shown in Table 11, above. After 1300 pore volumes were injected, improvement factors of 1.99 and 1.81 were calculated for flow rates 125 mL/hour and 250 mL/hour, respectively. The core pressure was then changed to 700 psi (4.8×10⁶ Pa), and Synthetic Fluid 4, which has volatile oil behavior, was injected. Three additional post-treatment two-phase core floods were carried out with a total of 1100 pore volumes of Synthetic Fluid 4 at the two different flow rates. The k_{rg} values and improvement factors obtained after 450 pore volumes are shown in Table 11, above. After 1100 pore volumes were injected, improvement factors of 1.4 and 1.5 were calculated for flow rates 250 mL/hour and 125 mL/hour, respectively.

### Example 19

Example 19 was carried out using the methods and conditions of Example 3 with the core described in Table 10, but with the following modifications. An oven temperature of 155° F. (68° C.) was used, and Synthetic Fluid 4 was used. The treatment composition was prepared by combining the Epoxide Oligomer described above and a 70/30 (w/w) solution of 2-butoxyethanol/ethanol to make 400 grams of a 2% by weight solution of the Epoxide Oligomer. The core pressure was adjusted to 900 psi (6.2×10⁶ Pa), 1600 psi (1.1×10⁷ Pa), 2500 psi (1.7×10⁷ Pa), 3100 psi (2.1×10⁷ Pa), and 3500 psi (2.4×10⁷ Pa), under which conditions Synthetic Fluid 4 exhibited volatile oil behavior with liquid dropouts of 7.5%, 16%, 30%, 43%, and 64%, respectively. A flow rate of 150 mL/hour was used. The k_{rg} value and initial improvement factor obtained after 200 pore volumes at 900 psi (6.2×10⁶ Pa) are shown in Table 11, above. The improvement factor decreased with increasing number of pore volumes injected at a given pressure and with increasing liquid dropouts. After 200 pore volumes at 900 psi (6.2×10⁶ Pa), the measured k_{rg} and improvement factor were 0.040 and 1.3, respectively. No improvement was observed at core pressures of 3100 psi (2.1×10⁷ Pa) or higher.

### Example 20

Example 20 was carried out according to the method of Example 7 except with the following modifications. The treatment composition was prepared by combining the Epoxide Oligomer described above and a 70/30 (w/w) solution of 2-butoxyethanol/ethanol to make 400 grams of a 2% by weight solution of the Epoxide Oligomer. Bauxite proppant (obtained from Sintex Minerals and Services, Inc., Houston, Tex., under the trade designation “SINTEX 30/50”) was used instead of the sand. The aperture of the fracture was 0.16 cm. The core flood was carried out at 1000 psi (6.8×10⁶ Pa). Three post-treatment core floods were carried out for a total of 2000, 3000, and 4000 pore volumes, respectively. In general, the k_{rg} decreased with increasing gas velocity. Therefore a plot of the pressure drop/velocity vs. velocity was made, and the k_{rg} was calculated from the intercept to correct for non-Darcy flow effects using the Forscheimer equation. The results are shown in Table 13, below.

TABLE 13

| | | Pore volumes | Improvement |
|---|---|---|---|
| Pre-treatment k_{rg} | Post-treatment k_{rg} | injected | Factor |
| 0.136 | 0.263 | 2000 | 1.9 |
| | 0.251 | 3000 | 1.85 |
| | 0.213 | 4000 | 1.6 |

Surface fluorine content was determined by X-ray Photoelectron Spectroscopy (XPS), using a Kratos Model AXIS Ultra DLD (Kratos Analytical Inc., Chestnut Ridge, N.Y.) equipped with a high-powered Al monochromator for sandstone and limestone treated with N-methyl-N-(oxiran-2-ylmethyl)perfluorobutanesulfonamide-1 and N-methyl-N-(oxiran-2-ylmethyl)perfluorobutanesulfonamide-2. A sandstone block obtained from Cleveland Quarries under the trade designation “BEREA SANDSTONE” and a Texas Cream Limestone block obtained from Texas Quarries were both treated with a 2% by weight solution of N-methyl-N-(oxiran-2-ylmethyl)perfluorobutanesulfonamide-1 in isopropanol, and the treated stone was heated overnight in an oven at either 75° F. (24° C.) or 175° F. (79° C.). The procedure was repeated with a 2% by weight solution of N-methyl-N-(oxiran-2-ylmethyl)perfluorobutanesulfonamide-2 in isopropanol. For some of these samples, the sandstone or limestone was treated at 24° C. overnight with a 0.2% by weight solution of dopamine in water with sodium bicarbonate added to adjust the pH to 8.5. The dopamine treatment was carried out before the epoxide treatment. The results are shown in Table 14, below.

A comparison of imbibition was made between (2,2,3,3,4,4,5,5,6,6,7,7,8,8,9,9,9-heptadecafluorononyl)oxirane (C) and [2,2,3,3,4,4,5,5,6,6,7,7,8,8,9,9,10,11,11,11-eicosafluoro-10-(trifluoromethyl)undecyl]oxirane (D) (obtained from Sigma-Aldrich). Each of C and D was dissolved at 1% by weight in ethanol and isopropanol. The resulting solutions were used to treat thin 1-inch (2.54 cm) diameter samples of sandstone (obtained from Cleveland Quarries) and limestone (obtained from Texas Quarries) overnight. The samples were then dried. Drops of water and n-decane were added to each substrate, and the imbibition rates were measured and compared. For the samples treated with D, both water and n-decane were imbibed quickly or immediately. For the samples treated with C, n-decane imbibition was slow, and water imbibition was stopped.

TABLE 14

| | | | | % Fluorine on |
|---|---|---|---|---|
| substrate | temperature | dopamine | Epoxide | surface |
| sandstone | 75° F. (24° C.) | no | 1 | 48 |
| sandstone | 75° F. (24° C.) | yes | 1 | 70 |
| sandstone | 75° F. (24° C.) | no | 2 | 22 |
| sandstone | 75° F. (24° C.) | yes | 2 | 24 |
| sandstone | 175° F. (79° C.) | no | 1 | 45 |
| sandstone | 175° F. (79° C.) | yes | 1 | 75 |
| sandstone | 175° F. (79° C.) | no | 2 | 22 |
| sandstone | 175° F. (79° C.) | yes | 2 | 55 |
| limestone | 75° F. (24° C.) | no | 1 | 48 |
| limestone | 75° F. (24° C.) | yes | 1 | 58 |
| limestone | 75° F. (24° C.) | no | 2 | 24 |
| limestone | 75° F. (24° C.) | yes | 2 | 72 |
| limestone | 175° F. (79° C.) | no | 1 | 58 |
| limestone | 175° F. (79° C.) | yes | 1 | 56 |
| limestone | 175° F. (79° C.) | no | 2 | 38 |
| limestone | 175° F. (79° C.) | yes | 2 | 45 |

Various modifications and alterations of this disclosure may be made by those skilled in the art without departing from the scope and spirit of this invention, and it should be understood that this invention is not to be unduly limited to the illustrative embodiments set forth herein.

1. A method comprising treating a hydrocarbon-bearing formation with a composition comprising a fluorinated epoxide.

2. The method according to claim 1, wherein the composition further comprises a fluorinated glycol.

3. The method according to claim 1, wherein the fluorinated epoxide is represented by formula: 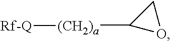
wherein
Rf is a partially or fully fluorinated aliphatic group optionally interrupted with at least one oxygen atom or a perfluoropolyether having at least 10 fluorinated carbon atoms and at least three —O— groups;
Q is selected from the group consisting of a bond, alkylene, arylene, alkylarylene, arylalkylene, —O—, —C(O)—, —S(O)₀₋₂—, —N(R)—, —SO₂N(R)—, —C(O)N(R)—, —C(O)—O—, —O—C(O)—, —O—C(O)—N(R)—, —N(R)—C(O)—O—, and —N(R)—C(O)—N(R)—, wherein alkylene, arylene, alkylarylene, and arylalkylene are each optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, and wherein R is selected from the group consisting of hydrogen, alkyl having up to 4 carbon atoms, 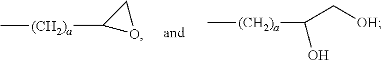
and
each a is independently 0 or 1.

4. The method according to claim 1, wherein the fluorinated epoxide comprises at least one of: 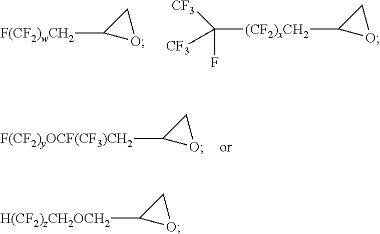
wherein
w and z are each independently 1 to 10;
x is a number from 0 to 10; and
y is a number from 1 to 8.

5. The method according to claim 1, wherein the fluorinated epoxide is 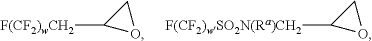
or a combination thereof, wherein
w is a number from 6 to 10;
w′ is a number from 3 to 6; and
R^{a} is alkyl having up to 4 carbon atoms.

6. The method according to claim 1, wherein the fluorinated epoxide is a polymeric fluorinated epoxide comprising a first divalent unit represented by formula: 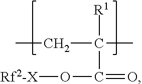
and a second divalent unit comprising a pendent epoxide,
wherein
Rf² is a fluoroalkyl group optionally containing at least one —O— group or a perfluoropolyether having at least 10 fluorinated carbon atoms and at least three —O— groups;
X is selected from the group consisting of alkylene, arylene, alkylarylene, arylalkylene, each optionally containing at least one of —O—, —C(O)—, —S(O)₀₋₂—, —N(R²)—, —SO₂N(R²)—, —C(O)N(R²)—, —C(O)—O—, —O—C(O)—, —OC(O)—N(R²)—, —N(R²)—C(O)—O—, or —N(R²)—C(O)—N(R²)—, wherein each R² is independently hydrogen or alkyl having up to 4 carbon atoms; and
R¹ is hydrogen or alkyl having up to 4 carbon atoms.

7. The method according to claim 6, wherein Rf² is a polyfluoropolyether group having at least 10 fluorinated carbon atoms and at least three —O— groups, wherein X is alkylene, —C(O)—N(R²)-alkylene-, or —C(O)—O-alkylene-, and wherein the second divalent units are represented by formula: 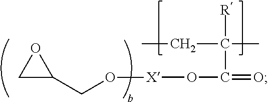
wherein
X′ is alkylene optionally containing at least one —O— group;
R′ is hydrogen or alkyl having up to four carbon atoms; and
b is 1 or 2.

8. The method according to claim 1, wherein the composition comprises at least one of organic solvent or water.

9. The method according to claim 8, wherein the organic solvent comprises at least one of a monohydroxy alcohol having up to 4 carbon atoms, ethylene glycol, acetone, a glycol ether, supercritical carbon dioxide, or liquid carbon dioxide.

10-12. (canceled)

13. The method according to claim 1, wherein the hydrocarbon-bearing formation has at least one fracture, and wherein the fracture has a plurality of proppants therein.

14. (canceled)

15. The method according to claim 1, wherein the hydrocarbon-bearing formation has a temperature of less than 135° C.

16. (canceled)

17. An article comprising a surface, wherein at least a portion of the surface is treated with a ring-opened product of a fluorinated epoxide, wherein the article comprises a hydrocarbon-bearing formation or a particle, wherein the particle comprises one of sand, resin-coated sand, ceramic, thermoplastic, clay, bauxite, nut or seed shells, fruit pits, or wood, and wherein the ring-opened product is free of repeating units represented by formula —CH₂—CH₂—O—.

18. The article according to claim 17, wherein the ring-opened product comprises at least one of: 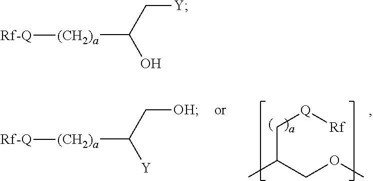
wherein
Rf is a partially or fully fluorinated aliphatic group optionally interrupted with at least one oxygen atom or a polyfluoropolyether group having at least 10 carbon atoms and at least three —O— groups;
Q is selected from the group consisting of a bond, alkylene, arylene, alkylarylene, arylalkylene, —O—, —C(O)—, —S(O)₀₋₂—, —N(R)—, —SO₂N(R)—, —C(O)N(R)—, —C(O)—O—, —O—C(O)—, —O—C(O)—N(R)—, —N(R)—C(O)—O—, and —N(R)—C(O)—N(R)—, wherein alkylene, arylene, alkylarylene, and arylalkylene are each optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, and wherein R is selected from the group consisting of hydrogen, alkyl having up to 4 carbon atoms, and 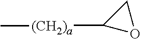
or a ring-opened analog thereof;
each a is independently 0 or 1; and
Y is hydroxyl or a bond to the surface.

19. The article according to claim 17, wherein the ring-opened product of the fluorinated epoxide is a polymer comprising a first divalent unit represented by formula: 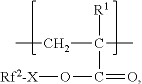
and a second divalent unit comprising a pendent ring-opened epoxide,
wherein
Rf² is a fluoroalkyl group optionally containing at least one —O— group or a polyfluoropolyether group having at least 10 carbon atoms and at least three —O— groups;
X is selected from the group consisting of alkylene, arylene, alkylarylene, arylalkylene, each optionally containing at least one of —O—, —C(O)—, —S(O)₀₋₂—, —N(R²)—, —SO₂N(R²)—, —C(O)N(R²)—, —C(O)—O—, —O—C(O)—, —OC(O)—N(R²)—, —N(R²)—C(O)—O—, or —N(R²)—C(O)—N(R²)—, wherein each R² is independently hydrogen or alkyl having up to 4 carbon atoms; and
R¹ is hydrogen or alkyl having up to 4 carbon atoms.

20-22. (canceled)

23. A method of making proppants, the method comprising treating a plurality of particles with a composition comprising a fluorinated epoxide, wherein the plurality of particles comprises at least one of sand, resin-coated sand, ceramic, thermoplastic, clay, bauxite, nut or seed shells, fruit pits, or wood.

24. The method according to claim 23, wherein the fluorinated epoxide is represented by formula: 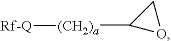
wherein
Rf is a partially or fully fluorinated aliphatic group optionally interrupted with at least one oxygen atom or a polyfluoropolyether group having at least 10 carbon atoms and at least three —O— groups;
Q is selected from the group consisting of a bond, alkylene, arylene, alkylarylene, arylalkylene, —O—, —C(O)—, —S(O)₀₋₂—, —N(R)—, —SO₂N(R)—, —C(O)N(R)—, —C(O)—O—, —O—C(O)—, -O—C(O)—N(R)—, —N(R)—C(O)—O—, and —N(R)—C(O)—N(R)—, wherein alkylene, arylene, alkylarylene, and arylalkylene are each optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, and wherein R is selected from the group consisting of hydrogen, alkyl having up to 4 carbon atoms, and 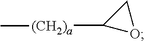
and
each a is independently 0 or 1.

25. The method according to claim 24, wherein the fluorinated epoxide comprises at least one of: 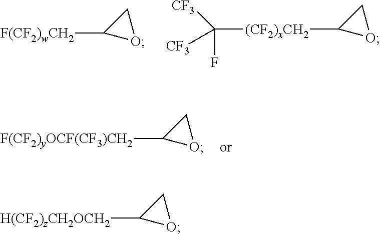
wherein
w and z are each independently 1 to 10;
x is a number from 0 to 10; and
y is a number from 1 to 8.

26. The method according to claim 25, wherein the fluorinated epoxide is 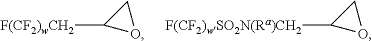
or a combination thereof, wherein
w is a number from 6 to 10;
w′ is a number from 3 to 6; and
R^{a} is alkyl having up to 4 carbon atoms.

27. The method according to claim 23, wherein the fluorinated epoxide is a polymeric fluorinated epoxide comprising a first divalent unit represented by formula: 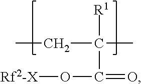
and a second divalent unit comprising a pendent epoxide,
wherein
Rf² is a fluoroalkyl group optionally containing at least one —O— group or a polyfluoropolyether group having at least 10 carbon atoms and at least three —O— groups;
X is selected from the group consisting of alkylene, arylene, alkylarylene, arylalkylene, each optionally containing at least one of —O—, —C(O)—, —S(O)₀₋₂—, —N(R²)—, —SO₂N(R²)—, —C(O)N(R²)—, —C(O)—O—, —O—C(O)—, —OC(O)—N(R²)—, —N(R²)—C(O)—O—, or —N(R²)—C(O)—N(R²)—, wherein each R² is independently hydrogen or alkyl having up to 4 carbon atoms; and
R¹ is hydrogen or alkyl having up to 4 carbon atoms.

28. The method according to claim 27, wherein Rf² is a polyfluoropolyether group having at least 10 fluorinated carbon atoms and at least three —O— groups, wherein X is alkylene, —C(O)—N(R²)-alkylene-, or —C(O)—O-alkylene-, and wherein the second divalent units are represented by formula: 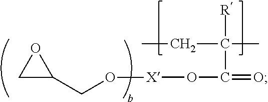
wherein
X′ is alkylene optionally containing at least one —O— group;
R′ is hydrogen or alkyl having up to four carbon atoms; and
b is 1 or 2.

29. (canceled)
